(19) United States
(12) Patent Application Publication
(10) Pub. No.: US 2009/0306973 A1
(43) Pub. Date: Dec. 10, 2009

(54) Sound Source Separation Apparatus and Sound Source Separation Method

(76) Inventors: Takashi Hiekata, Hyogo (JP); Takashi Morita, Hyogo (JP); Hiroshi Saruwatari, Nara (JP); Yoshimitsu Mori, Nara (JP)

Correspondence Address: Juan Carlos A. Marquez;c/o Stites & Harbison PLLC, 1199 North Fairfax Street, Suite 900, Alexandria, VA, 22314-1437, US

(21) Appl. No.: 12/223,069

(22) PCT Filed: Jan. 23, 2007
(86) PCT No.: PCT/JP2007/051009

§ 371 Date: Jul. 22, 2008

(30) Foreign Application Priority Data
Jan. 23, 2006 (JP) 2006-014419
Sep. 6, 2006 (JP) 2006-241861

(51) Int. Cl. G10L 21/00

(52) U.S. Cl. 704/205; 704/E21.001

(57) ABSTRACT

A sound source separation apparatus, includes: a plurality of sound input means into which a plurality of mixed sound signals in which sound source signals from a plurality of sound sources superimpose each other are input; first sound source separating means for separating and extracting SIMO signals corresponding to at least one sound source signal from the plurality of mixed sound signals by means of a sound source separation process of a blind source separation system based on an independent component analysis method; intermediate processing executing means for obtaining a plurality of intermediately processed signals by carrying out a predetermined intermediate processing including one of a selection process and a synthesizing process to a plurality of specified signals which is at least a part of the SIMO signals, for each of frequency components divided into a plurality; and second sound source separating means for obtaining separation signals corresponding to the sound source signals by applying a binary masking process to the plurality of intermediately processed signals or a part of the SIMO signals and the plurality of intermediately processed signals.

### TECHNICAL FIELD

The present invention relates to a sound source separation apparatus and a sound source separating method for identifying (separating) one or more individual sound signals from a plurality of mixed sound signals in which individual sound signals input from the respective sound sources via the respective sound input means superimpose each other in a state where a plurality of sound sources and a plurality of sound input means exist in a predetermined acoustic space.

### BACKGROUND ARTS

Where a plurality of sound sources and a plurality of microphones (sound input means) exist in a predetermined acoustic space, individual sound signals (hereinafter called mixed sound signals) in which individual sound signals (hereinafter called sound source signals) coming from a plurality of respective sound sources superimpose each other are acquired for each of the plurality of microphones. The system for processing to separate sound sources, which identifies (separates) the respective sound source signals based only on a plurality of mixed sound signals thus acquired or input, is a blind source separation system (hereinafter called BSS system).

Furthermore, as one of the sound source separation processes of the BSS system, there is another sound source separation process of the BSS system based on an independent component analysis method (hereinafter called ICA method). The BSS system based on the ICA method is a system that, utilizing that the sound signals are statistically independent from each other, identifies (separates) the sound source signals by optimizing a predetermined back-mixing matrix in a plurality of the mixed sound signals (time-series sound signals) input via a plurality of microphones and filter-processing the plurality of input mixed sound signals based on the optimized back-mixing matrix.

On the other hand, a sound source separation process based on binaural signal processing (separation) has been known as a sound source separation process. This separates sound sources by applying chronological gain adjustment to a plurality of input sound signals based on an auditory model of a human being, which is a sound source separation process that can be achieved with comparatively low arithmetic operation load.

### DISCLOSURE OF THE INVENTION

### Problems that the Invention is to Solve

However, in the sound source separation process by the BSS system based on the ICA method in which attention is directed to independency of the sound source signals (individual sound signals), there is a problem that, where the separation process is used in actual environments, the statistical amount cannot be estimated at high accuracy (that is, the back-mixing matrix cannot be sufficiently optimized) due to influences of transmittance characteristics of sound signals and background noise, etc., and sufficient sound source separation performance (identification performance of sound source signals) is not obtained.

Also, although in the sound source separation process based on the binaural signal processing, the process is simple and the arithmetic operation load is low, there is another problem that the robustness for positions of sound sources is poor, and the sound source separation performance is generally inferior.

On the other hand, there is a case where it is especially emphasized that sound signals from sound sources other than a specified sound source are included in separated sound signals as little as possible (that is, the sound source separation performance is high), depending on an object to which the sound separation source process is applied, and there is a case where it is especially emphasized that the quality of separated sound signals is good (that is, the spectral distortion is small). However, there is still another problem that the related sound source separation apparatus cannot carry out sound source separation responsive to such an emphasized target.

Therefore, it is an object of the present invention to provide a sound source separation apparatus and a sound source separating method capable of obtaining high sound source separation performance in diversified environments subjected to influences due to noise, and capable of processing to separate sound sources responsive to emphasized targets (sound source separation performance and sound quality).

### Means for Solving the Problems

In order to achieve the above-described object, according to the invention, there is provided a sound source separation apparatus, including: a plurality of sound input means into which a plurality of mixed sound signals in which sound source signals from a plurality of sound sources superimpose each other are input; first sound source separating means for separating and extracting SIMO signals corresponding to at least one sound source signal from the plurality of mixed sound signals by means of a sound source separation process of a blind source separation system based on an independent component analysis method; intermediate processing executing means for obtaining a plurality of intermediately processed signals by carrying out a predetermined intermediate processing including one of a selection process and a synthesizing process to a plurality of specified signals which is at least a part of the SIMO signals, for each of frequency components divided into a plurality; and second sound source separating means for obtaining separation signals corresponding to the sound source signals by applying a binary masking process to the plurality of intermediately processed signals or a part of the SIMO signals and the plurality of intermediately processed signals.

The sound source separating means may further include: intermediate processing parameter setting means for setting parameters used for the predetermined intermediate processing by predetermined operation inputs.

The intermediate processing executing means may correct, by predetermined weighting, signal levels for each of the frequency components with respect to the plurality of specified signals, and carry out one of the selection process and the synthesizing process for each of the frequency components to the plurality of corrected specified signals.

The intermediate processing executing means may carry out a process of selecting signals having the maximum signal level for each of the frequency components from the plurality of corrected specified signals.

The sound source separation apparatus may further include: short-time discrete Fourier transforming means for applying a short-time discrete Fourier transforming process to the plurality of mixed sound signals in a time-domain to transform to a plurality of mixed sound signals in a frequency-domain; FDICA sound source separating means for generating first separation signals corresponding to the sound source signals for each of the plurality of mixed sound source signals in the frequency-domain by applying a separation process based on a predetermined separation matrix to the plurality of mixed sound signals in the frequency-domain; subtracting means for generating second separation signals by subtracting the first separation signals from the plurality of mixed sound signals in the frequency-domain; and separation matrix computing means for computing the predetermined separation matrix in the FDICA sound source separating means by sequential computations based on the first separation signals and the second separation signals. The first sound source separating means may carry out a sound source separation process of a blind source separation system based on a frequency-domain SIMO independent component analysis method.

The first sound source separating means may carry out a sound source separation process of a blind source separation system based on a combined method in which a frequency-domain independent component analysis method and a projection back method are linked with each other.

The first sound source separating means may sequentially execute a separation process based on a predetermined separation matrix for division signals for each of the division signals obtained by dividing, by a predetermined cycle, the plurality of mixed sound signals input in time series to generate the SIMO signals, and carry out sequential computations to obtain the predetermined separation matrix subsequently used, based on the SIMO signals corresponding to all time bands of the division signals generated by the separation process. The number of times of the sequential computations may be limited to the number of times executable in a time of the predetermined cycle.

The first sound source separating means may sequentially execute a separation process based on a predetermined separation matrix for division signals for each of the division signals obtained by dividing, by a predetermined cycle, the plurality of mixed sound signals input in time series to generate the SIMO signals, and execute, in a time of the corresponding predetermined cycle, sequential computations to obtain the predetermined separation matrix subsequently used, based on the SIMO signals corresponding to a part at a leading top side of time bands of the division signals generated by the separation process.

In order to achieve the above-described object, according to the invention, there is also provided a sound source separating method, including: inputting a plurality of mixed sound signals in which sound source signals from a plurality of sound sources superimpose each other; separating and extracting SIMO signals corresponding to at least one sound source signal from the plurality of mixed sound source signals by means of a sound source separation process of a blind source separation system based on an independent component analysis method; obtaining a plurality of intermediately processed signals by carrying out a predetermined intermediate processing including one of a separation process and a synthesizing process to a plurality of specified signals which is at least a part of the SIMO signals, for each of frequency components divided into a plurality; and obtaining separation signals corresponding to the sound source signals by applying a binary masking process to the plurality of intermediately processed signals or a part of the SIMO signals and the plurality of intermediately processed signals.

### EFFECTS OF THE INVENTION

According to the present invention, since two-stage processes are carried out, in which a sound source separation process based on the comparatively simple binary masking process is added to the sound source separation process of the blind source separation system based on the independent component analysis method, high sound source separation performance can be brought about even in diversified environments subjected to influences such as noise.

In addition, with the present invention, the above-described intermediate processing is executed based on the SIMO signal obtained by the sound source separation process of the blind source separation system based on the independent component analysis method, and the binary masking process is applied to the intermediately processed signals. Therefore, it is possible that a sound source separation process to particularly increase the sound source separation performance is realized, or a sound source separation process to particularly improve the sound quality of sound signals after separation is realized. As a result, a sound source separation process that can flexibly respond to a specified emphasized target (the sound source separation performance or sound quality) can be brought about.

Also, a sound source separation process of the blind source separation system based on the frequency-domain SIMO independent component analysis method and a sound source separation process of the blind source separation system based on a combined method in which the frequency-domain independent component analysis method and the projection back method are linked with each other are carried, out, wherein the processing load can be greatly relieved in comparison with the sound source separation process of the blind source separation system based on the time-domain SIMO independent component analysis method.

Furthermore, the number of times of sequential computation of the above-described separation matrix in the first sound source separation process is restricted or the number of samples of the above-described SIMO signals used for the sequential computation is decreased, wherein real-time processing is enabled with the sound source separation performance secured.

### BRIEF DESCRIPTION OF THE DRAWINGS

FIG. 1 is a block diagram showing a brief configuration of a sound source separation apparatus X according to one embodiment of the present invention;

FIG. 2 is a block diagram showing a brief configuration of a sound source separation apparatus X1 according to Embodiment 1 of the present invention;

FIG. 3 is a block diagram showing a brief configuration of a related sound source separation apparatus Z1 that carries out a sound source separation process of the BSS system based on the TDICA method;

FIG. 4 is a block diagram showing a brief configuration of a related sound source separation apparatus Z2 that carries out a sound source separation process based on the TD-SIMO-ICA method;

FIG. 5 is a block diagram showing a brief configuration of a related sound source separation apparatus Z3 that carries out a sound source separation process based on the FDICA method;

FIG. 6 is a block diagram showing a brief configuration of a related sound source separation apparatus Z4 that carries out a sound source separation process based on the FD-SIMO-ICA method;

FIG. 7 is a block diagram showing a brief configuration of a related sound source separation apparatus Z5 that carries out a sound source separation process based on the FDICA-PB method;

FIG. 8 is a view describing a binary masking process;

FIG. 9 is a schematic view showing the first example (where the respective frequency components do not superimpose each other in sound source signals) of signal level distribution for each of the frequency components at signals before and after the binary masking process is applied to the SIMO signal;

FIG. 10 is a schematic view showing the second example (where the respective frequency components superimpose each other in sound source signals) of signal level distribution for each of the frequency components at signals before and after the binary masking process is applied to the SIMO signal;

FIG. 11 is a schematic view showing the third example (where the level of the target sound source signals is comparatively low) of signal level distribution for each of the frequency components at signals before and after the binary masking process is applied to the SIMO signal;

FIG. 12 is a schematic view showing the description of the first example of a sound source separation process with respect to the SIMO signal in the sound source separation apparatus X1;

FIG. 13 is a schematic view showing the description of the second example of a sound source separation process with respect to the SIMO signal in the sound source separation apparatus X1;

FIG. 14 is a view showing experimental conditions for evaluation of sound source separation performance using the sound source separation apparatus X1;

FIG. 15 is a graph describing the sound source separation performance and sound quality when sound source separation is carried out under predetermined experimental conditions by each of the related sound source separation apparatus and the sound source separation apparatus according to the present invention;

FIG. 16 is a timing chart describing the first example of separation matrix computation in the sound source separation apparatus X;

FIG. 17 is a timing chart describing the second example of separation matrix computation in the sound source separation apparatus X; and

FIG. 18 is a schematic view showing the description of the third example of a sound source separation process with respect to the SIMO signals in the sound source separation apparatus X1.

### DESCRIPTION OF SYMBOLS

X Sound source separation apparatus according to embodiments of the present invention
X1 Sound source separation apparatus according to Embodiment 1 of the present invention
1,2 Sound sources
1 SIMO-ICA processing portion
11, 11f Separation filter processing portions
12 Fidelity controller
13 ST-DFT processing portion
14 Inverse matrix computation portion
15 IDFT processing portion
21,22 Binaural signal processing portions
31 Comparator in binary masking process
32 Separator in binary masking process
41,42 Intermediate processing portions
111,112 Microphones

### BEST MODE FOR CARRYING OUT THE INVENTION

Hereinafter, with reference to the accompanying drawings, a description is given of embodiments of the present invention in order to understand the present invention. Also, the following embodiments are only examples in which the present invention is embodied, and are not those that limit the technical scope of the present invention.

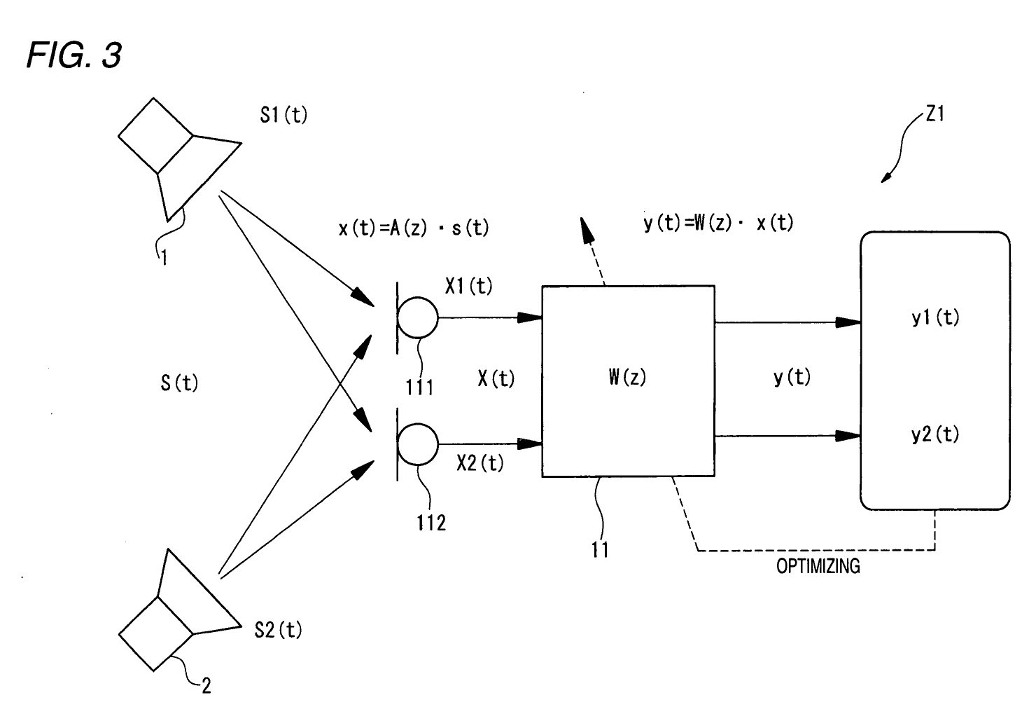

First, before the embodiments of the present invention are described, a description is given of a sound source separation apparatus of a blind source separation system based on various types of ICA methods (the BSS system based on the ICA method) with reference to block diagrams based on FIG. 3 through FIG. 7.

In addition, a sound source separation process described below and an apparatus to carry out the process are a sound source separation process for generating separation signals having one or more sound signals separated (identified) from a plurality of mixed sound signals in which individual sound signals (hereinafter called sound source signals) from the respective sound source superimpose each other and which are input via the respective microphones in a state where a plurality of sound sources and a plurality of microphones (sound input devices) exist in a predetermined acoustic space or an apparatus for carrying out the process.

FIG. 3 is a block diagram showing a brief configuration of a related sound source separation apparatus that carries out a sound source separation process of the BSS system based on the time-domain independent component analysis method (called TDICA), which is a type of the ICA method.

The sound source separation apparatus Z carries out, using a separation filter processing portion 11, sound source separation by applying a filter process by a separation matrix W(z) with respect to two channels (the number of microphones) of mixed sound signals x1(t) and x2(t) that are obtained by inputting sound source signals S1(t) and S2(t) (sound signals for each of the sound sources) from two sound sources 1 and 2 by means of two microphones 111 and 112.

FIG. 3 shows an example of carrying out sound source separation based on the two-channels (the number of microphones) of mixed sound signals x1(t) and x2(t) that are obtained by inputting sound source signals S1(t) and S2(t) (individual sound source signals) from two sound sources 1 and 2 by means of the two microphones 111 and 112. However, these are the same even if the number of channels is more than two channels. In the case of sound source separation of the BSS system based on the ICA method, (the number n of channels of input mixed sound signals (that is, the number of microphones)) may be equal to or more than (the number m of sound sources).

The sound source signals from a plurality of sound sources are, respectively, superimposed on the mixed sound signals x1(t) and x2(t) collected by a plurality of microphones 111 and 112, respectively. Hereinafter, the mixed sound signals x1(t) and x2(t) may be collectively expressed to be x(t). The mixed sound signals x(t) are expressed as convoluted signals, with respect to time and space, of the sound source signals S(t), and may be expressed as Expression (1) below.

### [Expression 1]

x(t)=A(z)·s(t) (1)

where A(z) is a space matrix when sounds are input from sound sources to microphones.

The sound source separation by the TDICA method is subjected to logic based on that, if it is utilized that the respective sound sources of the above-described sound source signals S(t) are statistically independent from each other, S(t) can be presumed if the x(t) is found, that is, the sound sources can be separated from each other.

Herein, if the separation matrix used for the corresponding sound source separation process is W(z), the separation signals (that is, identification signals) y(t) may be expressed by Expression (2) below.

### [Expression 2]

y(t)=W(z)·x(t) (2)

where W(z) may be obtained from output y(t) by sequential computation. Also, the separation signals can be obtained by the number of channels.

Also, a sound source synthesizing process forms a matrix equivalent to an inverse computation process based on information regarding this W(z) and carries out inverse computation using the same.

By carrying out the sound source separation of the BSS system based on such an ICA method, sound source signals of singing voices and sound source signals of musical instruments can be separated (identified) from mixed sound signals equivalent to a plurality of channels in which, for example, singing voices of human beings and sounds of musical instruments are mixed.

Herein, Expression (3) may be rewritten and expressed as shown below:

$$\begin{matrix}[ Expression 3 ] & \\ y ( t ) = {\sum }_{n = 0}^{D - 1} w ( n ) x ( t - n ) & ( 3 )\end{matrix}$$

where D is the number of taps of separation filter W(n).

And, the separation filter (separation matrix) W(n) in Expression (3) is sequentially computed based on the following Expression (4). That is, by sequentially applying output y(t) of the previous time (j) to Expression (4), W(n) of this time (j+1) is acquired.

$$\begin{matrix}[ Expression 4 ] & \\ {w}^{[ j + 1 ]} ( n ) = {w}^{[ j ]} ( n ) - α {\sum }_{d = 0}^{D - 1} \{ off - diag {〈 \begin{matrix}ϕ ( {y}^{[ j ]} ( t ) ) {y}^{[ j ]} \\ {( t - n + d )}^{T}\end{matrix} 〉}_{t} \} \cdot {w}^{[ j ]} ( d ) & ( 4 )\end{matrix}$$

where α is an updating coefficient, [j] is the number of times of updating, and < . . . >ₜ is time average. off-diag X expresses a computation process by which all the diagonal elements of matrix X are replaced to be zero, and φ ( . . . ) expresses an appropriate non-linear vector function having a sigmoid function as elements.

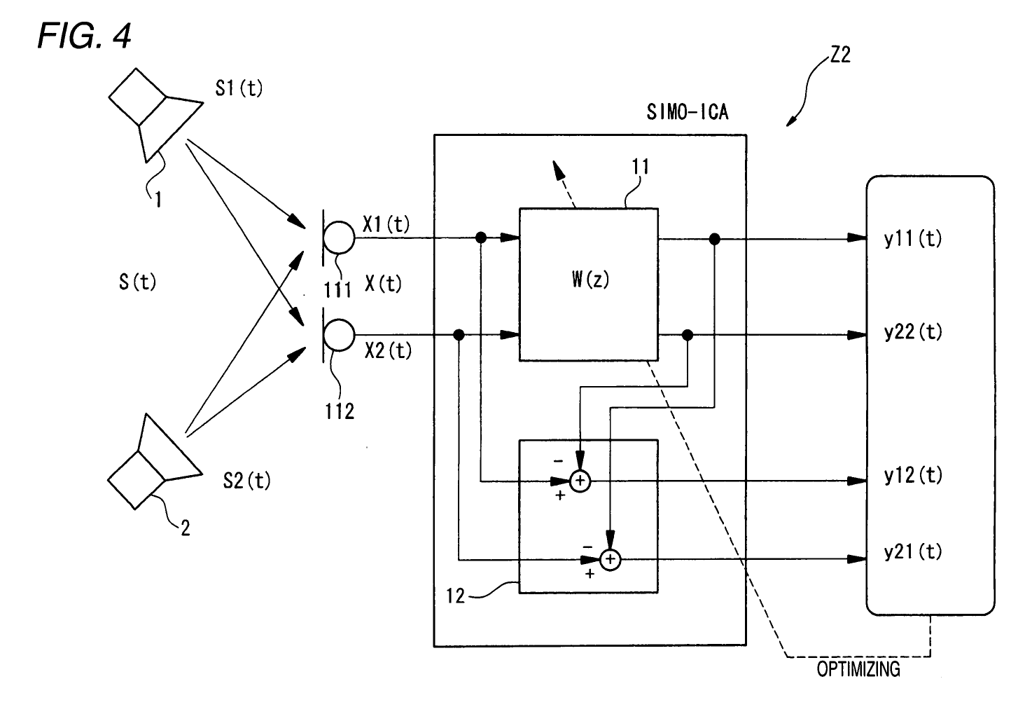

Next, using a block diagram of FIG. 4, a description is given of a configuration of a related sound source separation apparatus Z2 that carries out a sound source separation process based on a time-domain SIMO independent component analysis method (hereinafter called a TD-SIMO-ICA method) that is a type of the TDICA method. Also, FIG. 4 shows an example that carries out sound source separation based on two-channels (the number of microphones) of mixed sound signals x1(t) and x2(t). However, three or more channels may be acceptable.

The features of sound source separation based on the TD-SIMO-ICA method reside in the point that separation signals (identification signals) are separated (subtracted), by the fidelity controller 12 shown in FIG. 4, from respective mixed sound signals xi(t), which are microphone input signals, via the sound source separation process (the sound source separation process based on the TCICA method) by the separation filter process, and the separation filter W(Z) is updated (subjected to sequential computation) by evaluating the statistical independency of signal components obtained by the subtraction. Herein, the separation signals (identification signals) subtracted from the respective mixed sound signals xi(t) are all the remaining separation signals excepting separation signals each differing from each other (separation signals obtained by the sound source separation based on the corresponding mixed sound signals). Therefore, two separation signals (identification signals) will be obtained for each of the channels (microphones), and two separation signals will be obtained for each of the sound source signals Si(t). In the example of FIG. 4, separation signals y11(t) and 12(t), and separation signals y22(t) and y21(t) are, respectively, the separation signals (identification signals) corresponding to the same sound source signals. Also, with respect to the subscripts (numerals) of the separation signal y, the numeral of the former stage shows the identification number of the sound source, and the numeral in the latter stage shows the identification number of the microphone (that is, channel) (this is the same as in the subsequent description).

Thus, in a state where a plurality of sound sources and a plurality of microphones exist in a specified acoustic space, where one or more sound source signals are separated (identified) from a plurality of mixed sound signals in which sound source signals (individual sound signals) from the respective sound sources, which are input via the respective microphones, superimpose each other, a plurality of separation signal (identification signal) groups obtained for each of the sound source signals are called SIMO (single-input multiple-output) signals. In the example of FIG. 4, a combination of separation signals y11(t) and y12(t) and a combination of separation signals y22(t) and y21(t) are, respectively, SIMO signals.

Herein, an updating expression of W(n) in which the separation filter (separation matrix) W(Z) is updated for description is expressed as the next Expression (5).

$$\begin{matrix}[ Expression 5 ] & \\ {w}_{ICA 1}^{[ j + 1 ]} ( n ) = {w}_{ICA 1}^{[ j ]} ( n ) - α {\sum }_{d = 0}^{D - 1} \{ off - diag {〈 \begin{matrix}ϕ ( {y}_{ICA 1}^{[ j ]} ( t ) ) {y}_{ICA 1}^{[ j ]} \\ {( t - n + d )}^{T}\end{matrix} 〉}_{t} \} \cdot {w}_{ICA 1}^{[ j ]} ( d ) + α {\sum }_{d = 0}^{D - 1} \{ off - diag {〈 \begin{matrix}ϕ ( x ( t - \frac{D}{2} ) - {\sum }_{l = 1}^{L - 1} {y}_{ICA 1}^{[ j ]} ( t ) ) \cdot \\ {( \begin{matrix}x ( t - \frac{D}{2} - n + d ) - \\ {\sum }_{l = 1}^{L - 1} {y}_{ICA 1}^{[ j ]} ( t - n + d )\end{matrix} )}^{T}\end{matrix} 〉}_{t} \} \cdot ( I δ ( d - \frac{D}{2} ) - {\sum }_{l = 1}^{L - 1} {w}_{ICA 1}^{[ j ]} ( d ) ) & ( 5 )\end{matrix}$$

where α is an updating coefficient, [j] is the number of times of updating, and < . . . >ₜ is time average. off-diag X expresses a computation process by which all the diagonal elements of matrix X are replaced to be zero, and φ ( . . . ) expresses an appropriate non-linear vector function having a sigmoid function as elements. The subscript [ICA1] of W and y shows the l(el)th ICA component in the SIMO-ICA portion.

The Expression (5) is an expression in which the third term is added to Expression (4) described above. The third term is a portion for evaluating the independency of components of signals generated by the fidelity controller 12.

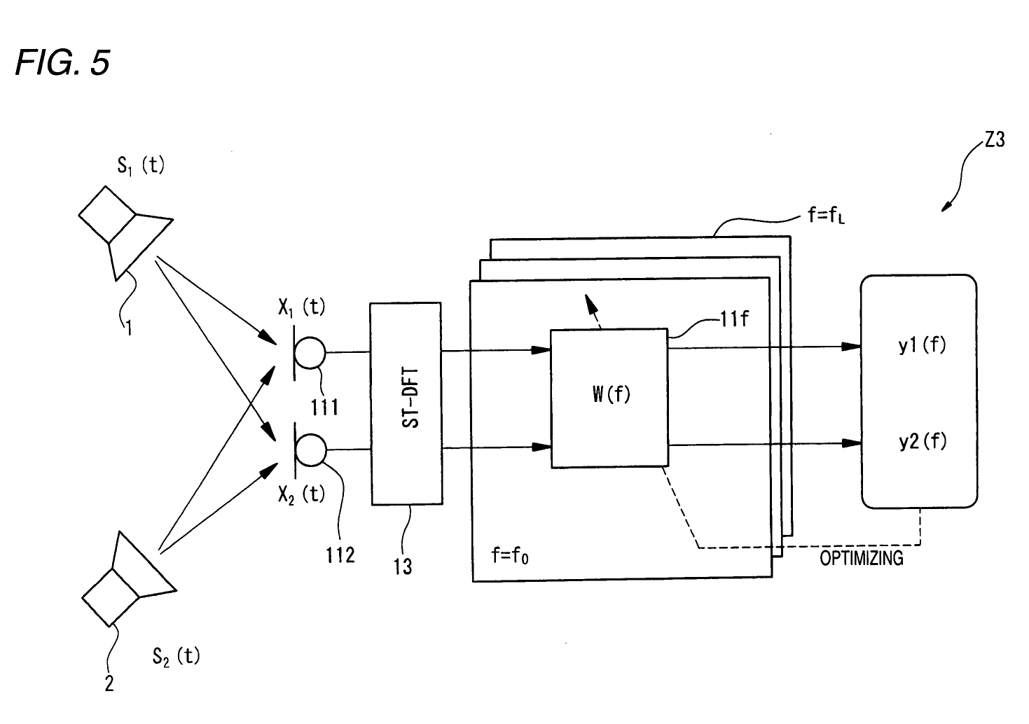

Next, using a block diagram of FIG. 5, a description is given of a related sound source separation apparatus Z3 that carries out a sound source separation process based on the FDICA (Frequency-Domain ICA), which is a type of the ICA method).

First, the FDICA method carries out short-time discrete Fourier transformation (hereinafter called ST-DFT process) for each of the frames in which input mixed sound signals x(t) are divided by a predetermined cycle by the ST-DFT processing portion 13, and carries out a short-time analysis of observation signals. And, the respective channels of signals (signals of the respective frequency components) after the ST-DFT process are subjected to a separation filter process based on a separation matrix W(f) by the separation filter processing portion 11f, thereby sound source separation (identifying the sound sources) is carried out. Herein, where it is assumed that f is a frequency bin, and m is an analysis frame number, the separation signals (identification signals) y(f,m) may be expressed as in Expression (6).

### [Expression 6]

Y(f,m)=W(f)·X(f,m) (6)

Herein, the updating expression of the separation filter W(f) may be expressed as in, for example, the next Expression (7).

### [Expression 7]

W_{(ICAl)}^{[i+1]}(f)=W_{(ICAl)}^{[i]}(f)−η(f)[off-diag{ [symbol] φ(Y_{(ICAl)}^{[i]}(f,m))Y_{(ICAl)}^{[i]}(f,m)^{H} [symbol] ₘ}]W_{(ICAl)}^{[i]}(f) (7)

where η(f) is an updating coefficient, [i] is the number of times of updating, < . . . > is time average, and H is Hermitian transposition. off-diag X expresses a computation process by which all the diagonal elements of matrix X are replaced to be zero, and φ ( . . . ) expresses an appropriate non-linear vector function having a sigmoid function as elements.

According to the FDICA method, the sound source separation process is handled as an instantaneously mixed matter in the respective narrow bands, wherein the separation filter (separation matrix) W(f) can be comparatively simply updated in a stable state.

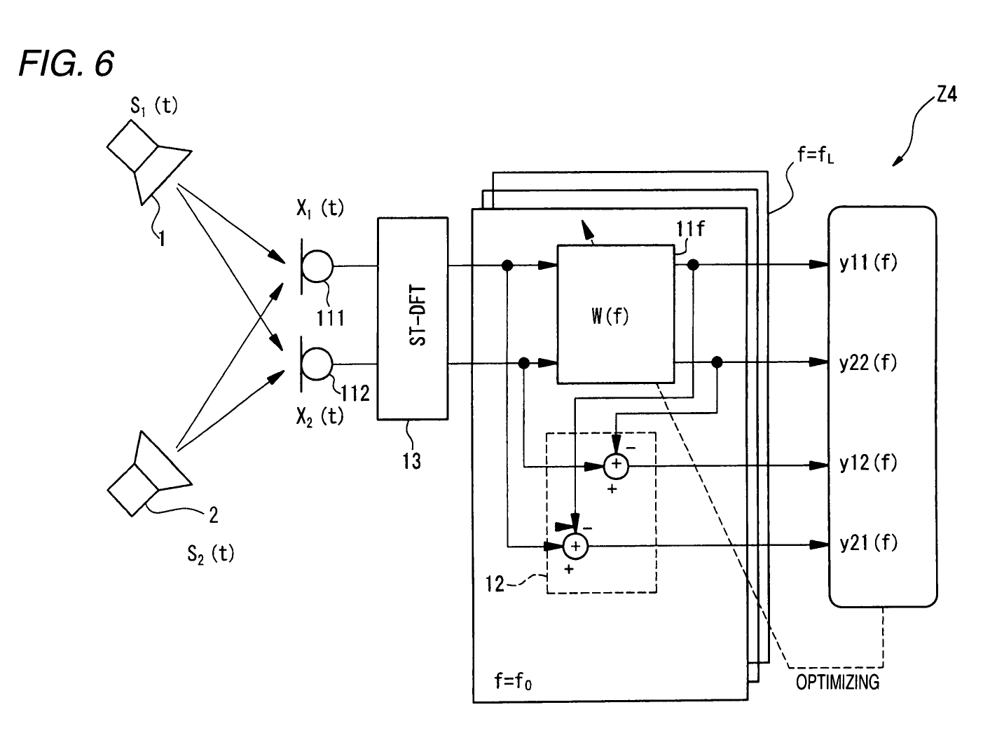

Next, using a block diagram shown in FIG. 6, a description is given of a sound source separation apparatus Z4 based on a frequency-domain SIMO independent component analysis method (hereinafter called FDSIMO-ICA method), which is a type of the FDICA method.

The FD-SIMO-ICA method subtracts, by the fidelity controller 12, separation signals (identification signals) separated (identified) by the sound source separation process based on the FDICA method (FIG. 5) from the respective signals that are subjected to the ST-DFT process with respect to the respective mixed sound signals xi(t) and evaluates the statistical independency of the signal components obtained by the subtraction as in the TD-SIMO-ICA method (FIG. 4) described above, and thereby updates (sequentially computes) the separation filter W(f).

In the sound source separation apparatus Z4 according to the FD-SIMO-ICA method, a plurality of the mixed sound signals x1(t) and x2(t) in the time-domain are subjected to the short-time discrete Fourier transforming process by the ST-DFT processing portion 13, and are transformed to a plurality of mixed sound signals x1(f) and x2(f) in the frequency-domain.

Next, a plurality of mixed sound signals x1(f) and x2(f) in the frequency-domain after transformation are subjected to a separation process (filter process) based on a predetermined separation matrix W(f) by the separation filter processing portion 11f, wherein the first separation signals y11(f) and y22(f) corresponding to either one of the sound source signals S1(t) or S2(t) are generated for each of the mixed sound signals.

Furthermore, the second separation signals y12(f) and y21(f) are generated, which are obtained by subtracting, by means of the fidelity controller 12, the remaining first separation signals other than the first separation signals (y22(f) separated based on y11(f) and x2(f) separated based on x1(f)) separated by the separation filter processing portion 11f based on the corresponding mixed sound signals, from a plurality of the respective mixed sound signals x1(f) and x2(f) in the above-described frequency-domain.

On the other hand, the separation matrix computation portion (not illustrated) carries out sequential computation based on both the first separation signals y11(f), x2(f) and the second separation signals y12(f), y21(f), and computes the above-described separation matrix W(f) used for the separation filter processing portion 11f.

Thereby, two separation signals (identification signals) will be obtained for each of the channels (microphones), and two or more separation signals (SIMO signals) will be obtained for each of the sound sources Si(t). In the example of FIG. 6, a combination of the separation signals y11(f) and y12(f) and a combination of the separation signals y22(f) and y21(f) are, respectively, SIMO signals.

Here, the separation matrix computing portion computes the separation matrix W(f) by the updating expression of a separation filter (separation matrix) W(f) expressed by the next Expression (8) based on the first separation signals and the second separation signals.

$$\begin{matrix}[ Expression 8 ] & \\ {W}_{( ICA 1 )}^{[ i + 1 ]} ( f ) = {W}_{( ICA 1 )}^{[ i ]} ( f ) - η ( f ) [ off - diag \{ {〈 \begin{matrix}ϕ ( {Y}_{( ICA 1 )}^{[ i ]} ( f , m ) ) \\ {{Y}_{( ICA 1 )}^{[ i ]} ( f , m )}^{H}\end{matrix} 〉}_{m} \} ] {W}_{( ICA 1 )}^{[ i ]} ( f ) - off - diag \{ {〈 ϕ ( X ( f , m ) - {\sum }_{l = 1}^{L - 1} {Y}_{( ICA 1 )}^{[ i ]} ( f , m ) ) {( X ( f , m ) - {\sum }_{l = 1}^{L - 1} {Y}_{( ICA 1 )}^{[ i ]} ( f , m ) )}^{H} 〉}_{m} \} ( I - {\sum }_{l = 1}^{L - 1} {W}_{( ICA 1 )}^{[ i ]} ( f ) ) ] & ( 8 )\end{matrix}$$

where η(f) is an updating coefficient, [i] is the number of times of updating, < . . . > is time average, and H is Hermitian transposition. off-diag X expresses a computation process by which all the diagonal elements of matrix X are replaced to be zero, and φ ( . . . ) expresses an appropriate non-linear vector function having a sigmoid function as elements.

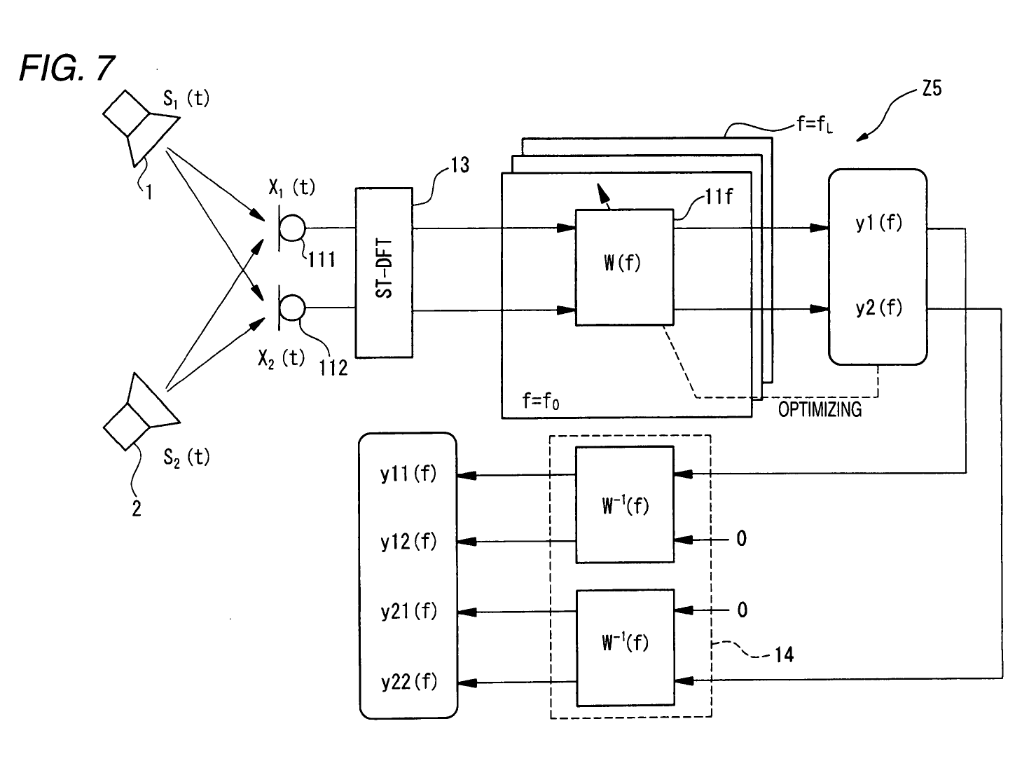

Next, using a block diagram shown in FIG. 7, a description is given of a related sound source separation apparatus Z5 that carries out a sound source separation process based on a combined method (hereinafter called the FDICA-PB method) in which the frequency-domain independent component analysis method being a type of the FDICA method and a projection back method are linked with each other.

The FDICA-PB method applies a computation process of an inverse matrix W−1(f) of the separation matrix W(f) by the inverse matrix computing portion 14 for each of the separation signals (identification signals) yi(f) obtained from the respective mixed sound signals xi(f) by the sound source separation process (FIG. 5) based on the above-described FDICA method, and acquires the final separation signals (identification signals of the sound source signals). Here, the remaining signal components other than the respective separation signals yi(f), of the signals that are the objects to be processed by the inverse matrix W−1(f) are input to be set to zero (0).

Accordingly, SIMO signals that are separation signals (identification signals) equivalent to the number of channels (in plurality) corresponding to each of the sound source signals Si(t) are obtained. In FIG. 7, the separation signals y11(f) and y12(f) and separation signals y21(f) and y22(f) are, respectively, separation signals (identification signals) corresponding to the same sound source signals, and a combination of the separation signals y11(f) and y12(f) being the signals after being processed by the respective inverse matrices W−1(f), and a combination of the separation signals y21(f) and y22(f) are, respectively, SIMO signals.

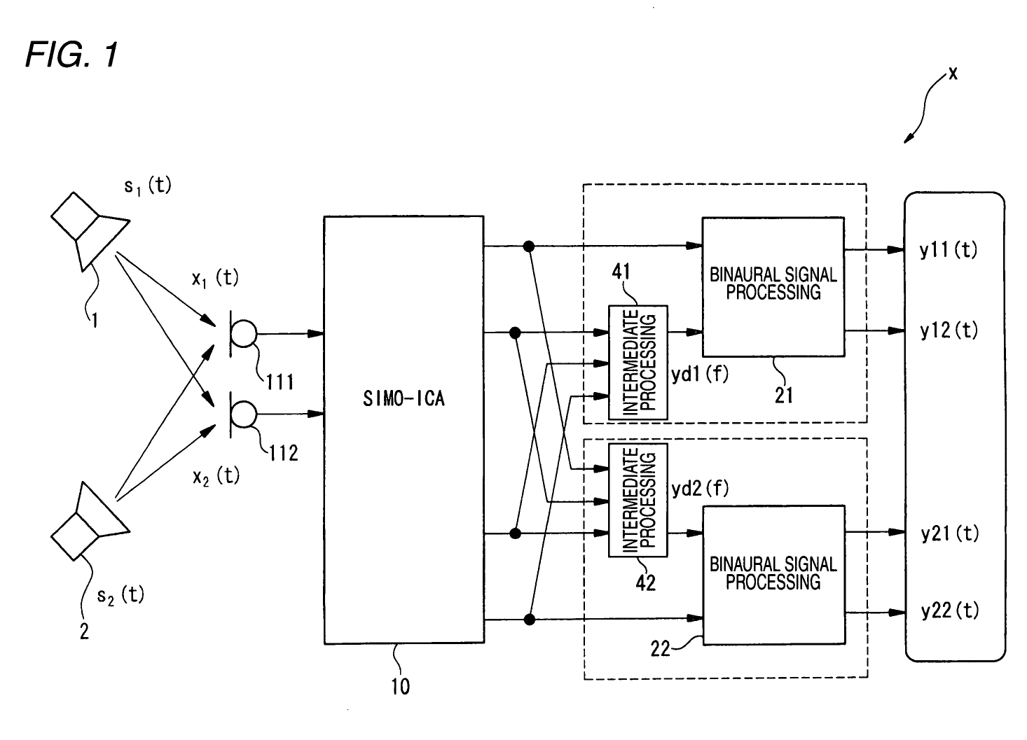

Hereinafter, using a block diagram of FIG. 1, a description is given of a sound source separation apparatus X according to the embodiments of the present invention.

The sound source separation apparatus X generates separation signals (identification signals) y obtained by separating (identifying) one or more sound source signals (individual sound signals) from a plurality of mixed sound signals Xi (t) in which sound source signals (individual sound signals) input from each of the sound sources 1 and 2 via the respective microphones 111 and 112 superimpose each other in a state where a plurality of sound sources 1, 2 and a plurality of microphones 111, 112 exist in a specified acoustic space.

And, the features of the sound source separation apparatus X reside in that the apparatus is provided with the configurational elements (1) through (3) below.

(1) A SIMO-ICA processing portion 10 that separates and generates SIMO signals (a plurality of separation signals corresponding to a single sound source) obtained by separating (identifying) one or more sound source signals Si(t) from a plurality of mixed sound signals Xi(t) by the sound source separation process of the blind source separation (BSS) system based on the independent component analysis method (ICA).
(2) Two intermediate processing executing portions 41 and 42 that carry out predetermined intermediate processing including a selection process or a synthesizing process for each of the frequency components divided into a plurality with respect to a plurality of signals that are a part of the SIMO signals generated by the SIMO-ICA processing portion 10, and output intermediately processed signals yd1(f) and yd2(f) obtained by the intermediate processing. Here, it is considered that division per frequency component is, for example, to make equal divisions based on a predetermined frequency bandwidth.

In addition, the intermediate processing executing portions 41, 42 shown in FIG. 1, respectively, carry out the above-described intermediate processing based on three separation signals (one example of specified signals) of the SIMO signals composed of four separation signals, and respectively output a single intermediately processed signal yd1(f) or yd2(f).

(3) Two binaural signal processing portions 21, 22 that use the above-described intermediately processed signals yd1(f) and yd2(f) obtained (output) by the intermediate processing executing portions 41, 42 and a part of the signals of the SIMO signals separated and generated by the SIMO-ICA processing portion 10 as input signals, respectively, and generate signals obtained by applying a binary masking process to the input signals as separation signals separated (identified) with respect to one or more sound source signals.

Also, the step along which the SIMO-ICA processing portion 10 carries out a sound source separation process is one example of the first sound source separation step, and the step along which the intermediate processing executing portions 41,42 carry out the above-described intermediate processing is one example of the intermediate processing executing step. Furthermore, the step along which the binaural signal processing portions 21, 22 carry out a binary masking process is one example of the second sound source separation step.

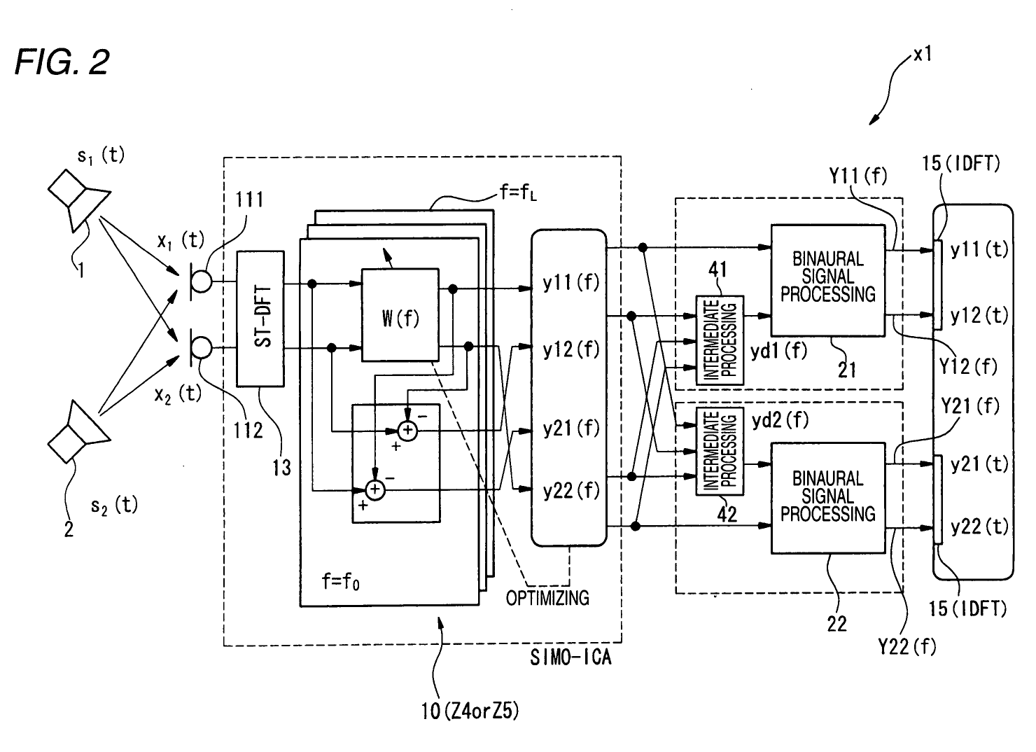

In the example shown in FIG. 2, the SIMO signals input into one binaural signal processing portion 21 are the SIMO signals that are not the object of intermediate processing by the intermediate processing executing portion 41 corresponding thereto. Similarly, the SIMO signals input into the other binaural signal processing portion 22 are the SIMO signals that are not the objects of the intermediate processing by the intermediate processing executing portion 42 corresponding thereto. However, the example shown in FIG. 2 is only one example, wherein such a configuration may be considered, in which the above-described SIMO signals (for example, y11(f) and y22(f) in FIG. 2) input into the binaural signal processing portions 21,22 are input as the object of the intermediate processing.

Here, it is considered that, as the SIMO-ICA processing portion 10, the sound source separation apparatus Z2 for carrying out a sound source separation process based on the TD-SIMO-ICA method shown in FIG. 4, the sound source separation apparatus Z4 for carrying out a sound source separation process based on the FD-SIMO-ICA method that carries out a sound source separation process based on the FD-SIMO-ICA method shown in FIG. 6, or the sound source separation apparatus Z5 for carrying out a sound source separation process based on the FDICA-PB method shown in FIG. 7 is adopted.

However, where the sound source separation apparatus Z2 based on the TD-SIMO-ICA method is adopted as the SIMO-ICA method processing portion 10 and where signals after being subjected to the sound source separation process based on the FD-SIMO-ICA method or the FDICA-PB method are transformed to the signals in the time-domain by the IDFT process (inverse discrete Fourier transformation process), an apparatus that applies the discrete Fourier transformation process (DFT process) before being subjected to the binary masking process is provided for the separation signals (identification signals) obtained by the SIMO-ICA processing portion 10 (the sound source separation apparatus Z2, etc.), whereby signals input into the binaural signal processing portions 21,22 and the intermediate processing executing portions 41,42 are transformed from the discrete signals in the time-domain to the discrete signals in the frequency-domain.

Furthermore, although not being illustrated in FIG. 1, the sound source separation apparatus X is also provided with an IDFT processing portion for transforming the output signals (discrete signals in the frequency-domain) of the binaural signal processing portion 21 to the signals in the time-domain (that is, for applying inverse discrete Fourier transformation thereto).

In addition, FIG. 1 shows a configurational example of applying a sound source separation process to the respective SIMO signals generated by the number of channels (the number of microphones) by means of the binary masking process. However, where it is an object to separate (identify) a part of sound source signals, such a configuration can be considered, which may apply the binary masking process only with respect to the SIMO signals corresponding to a part of the channels (or SIMO signals corresponding to a part of the microphones, or a part of decoded sound signals xi(t)).

Also, FIG. 1 shows an example in which two channels (that is, the number of microphones is two) are provided. However, if (the number n of channels of input mixed sound signals (that is, the number of microphones))≧(the number m of sound sources), three or more channels may be achieved by a similar configuration as above.

Herein, the respective components 10, 21, 22, 41 and 42 may be those that are, respectively, composed of a DSP (Digital Signal Processor) or a CPU and its peripheral devices (ROM, RAM, etc.), and programs executed by the DSP or the CPU thereof, or such that these are composed, so as to execute program modules corresponding to processes carried out by the respective components 10, 21, 22, 41 and 42, by a computer having a single CPU and its peripheral devices. Also, these may be proposed as a sound source separation program by which a predetermined computer is caused to execute processes of the respective components 10, 21, 22, 41 and 42.

On the other hand, the signal separation process in the above-described binaural signal processing portions 21,22 carries out sound source separation by applying a chronological gain adjustment to the mixed sound signals based on an auditory model of a human being as described above.

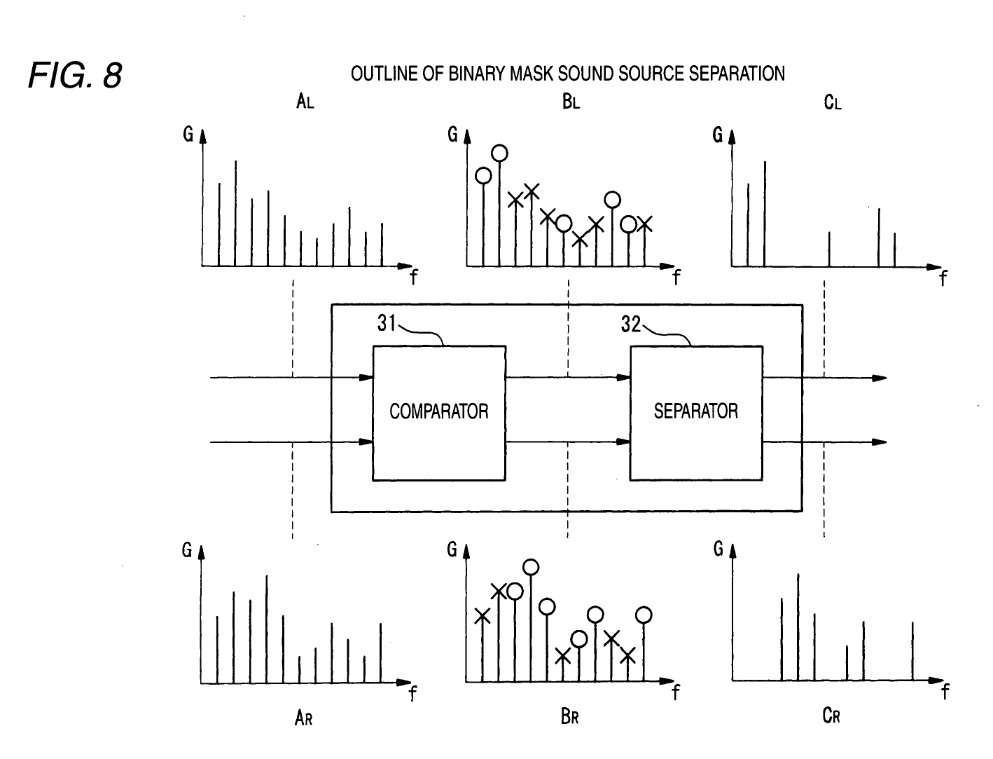

FIG. 8 is one example of a signal process resulting from the idea of binaural signal processing, and the drawing is a view to describe a binary masking process that is comparatively simple.

An apparatus and a program for executing a binary masking process includes a comparator 31 for carrying out a comparison process of a plurality of input signals (in the present invention, a plurality of sound signals that compose the SIMO signals) and a separator 32 for separating signals (separating sound sources) by applying gain adjustment to the input signals based on the results of the comparison process by the comparator 31.

In the binary masking process, first, the comparator 31 detects signal level (amplitude) distribution AL, AR for each of the frequency components for the respective input signals (SIMO signals in the present invention), and determines the intensities of the signal levels for the same frequency components.

In FIG. 8, BL and BR are views showing signal level distribution for each of the frequency components in the respective input signals and the intensity relationship (O, X) corresponding to the other corresponding signal level for each of the signal levels. In the drawing, marking [O] expresses that, based on the result of determination by the comparator 31, the intensity of the corresponding signal level is larger than the other corresponding signal level, and marking [X] similarly expresses that the corresponding signal level is smaller than the other corresponding signal level.

Next, the separator 32 generates separation signals (identification signals) by applying gain multiplication (gain adjustment) to the respective input signals based on the results (the results of intensity determination) of signal comparison by the comparator 31. It is considered, as an example of the simplest processing example in the separator 32, that with respect to input signals, the frequency components of input signals determined to have the most intensive signal level are multiplied by gain 1, and the frequency components of all the other input signals are multiplied by gain 0 (zero).

Thereby, separation signals CL and CR (identification signals) whose number is the same as that of the input signals can be obtained. One of the separation signals CL and CR corresponds to sound source signals that are the objects of identification of the input signals (separation signals (identification signals) of the above-described SIMO-ICA processing portion 10), and the other thereof corresponds to noise (sound source signals other than the sound source signals that are the objects of identification) mixed in the input signals. Therefore, high sound source separation performance can be brought about even in diversified environments subjected to influences of noise by two-stage processing (serial processing) by means of the SIMO-ICA processing portion 10 and the binaural signal processing portions 21,22.

Also, FIG. 8 shows an example of a binary masking process based on two input signals. However, the process based on three or more input signals is also similar thereto.

For example, the signal levels are compared with each other for each of the frequency components divided into a plurality with respect to the respective input signals of a plurality of channels, the most intensive signal level is multiplied by gain 1, and the others are multiplied by gain 0, wherein the signals obtained by the multiplication are added with respect to all the channels. And, the signals for each of the frequency components, which are obtained by the addition, are calculated for all the frequency components, and the signals in which these signals are combined may be made into output signals. Therefore, with respect to input signals of three or more channels, the binary masking process may be carried out as in the manner shown in FIG. 8.

### Embodiment 1

Hereinafter, Embodiment 1 employs, as the above-described SIMO-ICA processing portion 10 in the sound source separation apparatus X, the above-described sound source separation apparatus Z4 for carrying out a sound source separation process based on the FD-SIMO-ICA method that carries out a sound source separation process based on the FD-SIMO-ICA method shown in FIG. 6 or the above-described sound source separation apparatus Z5 for carrying out a sound source separation process based on the FDICA-PB method shown in FIG. 7. Also, FIG. 2 is a block diagram expressing a, brief configuration of the sound source separation apparatus X1 according to Embodiment 1 of the present invention. The drawing shows an example that employs the above-described sound source separation apparatus Z4 for carrying out a sound source separation process based on the FD-SIMO-ICA method shown in FIG. 6 as the SIMO-ICA processing portion 10 in the sound source separation apparatus X.

With the configuration of the sound source separation apparatus X1, the computation load can be reduced to be comparatively lower than in the configuration that employs a sound source separation process (FIG. 4) based on the TD-SIMO-ICA method with which the computation load is high because of the necessity for convolution computation.

Also, in the sound source separation apparatus X1 according to Embodiment 1, a predetermined value is set as the default value of separation matrix W(f) used in the SIMO-ICA processing portion 10.

In addition, the binaural signal processing portions 21,22 of the sound source separation apparatus X1 carry out a binary masking process.

With the sound source separation apparatus X1 shown in FIG. 2, two separation signals for each of two input channels (microphones), that is, four separation signals in total can be obtained by means of the SIMO-ICA processing portion 10, and the four separation signals are the SIMO signals.

Furthermore, one intermediate processing executing portion 41 inputs the separation signals y12(f), y21(f), y22(f) (one example of specified signals), which are a part of the SIMO signals, and executes the above-described intermediate processing based on these signals. Similarly, the other intermediate processing executing portion 42 inputs the separation signals y11(f), y12(f), y21(f) (one example of specified signals), which are a part of the SIMO signals, and executes the above-described intermediate processing based on these signals. A detailed description of the intermediate processing will be given later.

In addition, one binaural signal processing portion 21 inputs the intermediately processed signals yd1(f) output by the intermediate processing executing portion 41 corresponding thereto and separation signals y11(f) (a part of the SIMO signals) that are not the objects of the intermediate processing by the intermediate processing executing portion 41, carries out a binary masking process with respect to the input signals, and outputs the final separation signals Y11(f) and Y12(f). Also, the separation signals Y11(f) and Y12(f) of the frequency-domain are transformed to the separation signals y11(t) and y12(t) in a small time-domain by the IDFT processing portion 15 that executes an inverse discrete Fourier transformation process.

Similarly, the other binaural signal processing portion 22 inputs the intermediately processed signals yd2(f) output by the intermediate processing executing portion 42 corresponding thereto and separation signals y22(f) (a part of the SIMO signals) that are not the object of intermediate processing by the intermediate processing executing portion 42, carries out a binary masking process with respect to the input signals, and outputs the final separation signals Y21(f) and Y22(f). Furthermore, the separation signals Y21(f) and Y22(f) in the frequency-domain are transformed to the separation signals y21(t) and y22(t) in a small time-domain by the IDFT processing portion 15.

Furthermore, the binaural signal processing portions 21,22 are not necessarily limited to those that carry out a signal separation process equivalent to two channels, and it is considered that such a type in which three or more channels of binary masking processes are carried out.

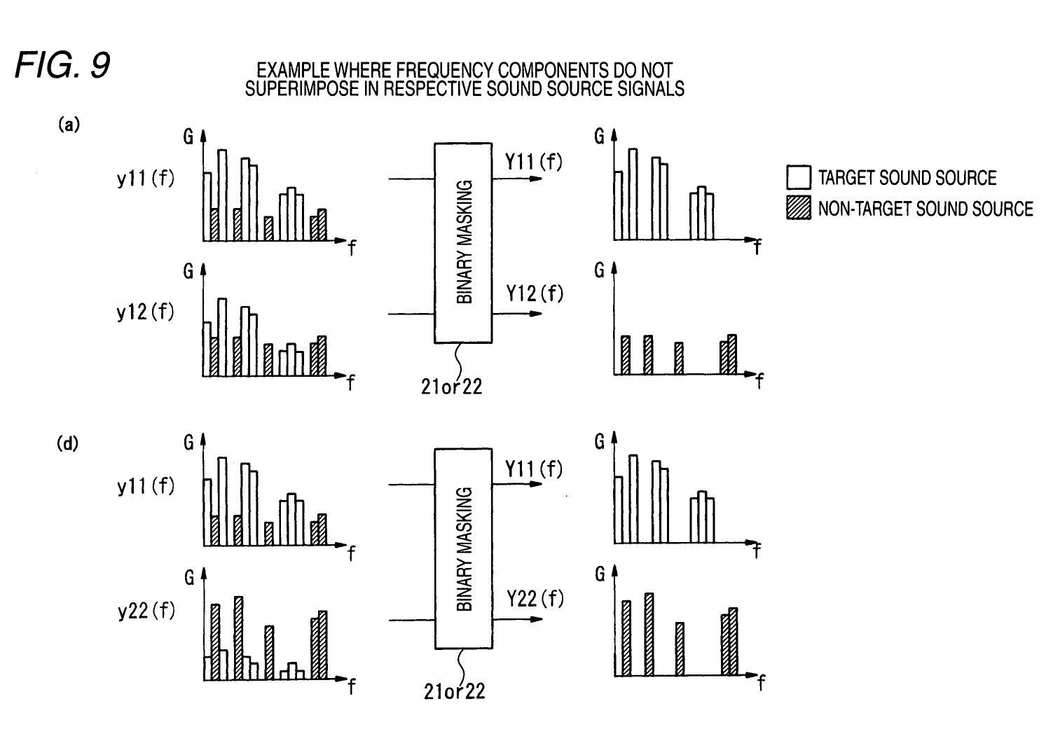

Next, referring to FIG. 9 through FIG. 11, a description is given of the relationship between a combination of input signals into the binaural signal processing portion 21 or 22, signal separation performance and sound quality of separation signals by the binaural signal processing portion 21 or 22 where the SIMO signals obtained by the SIMO-ICA processing portion 10 are used as input signals into the binaural signal processing portion 21 or 22. Herein, FIG. 9 through FIG. 11 are schematic views using bar graphs, which show examples (Example 1 through Example 3) of distribution of signal levels (amplitudes) for each of the frequency components in signals before and after applying a binary masking process to the SIMO signals. In addition, the binaural signal processing portion 21 or 22 carries out a binary masking process.

Also, in the following example, it is assumed that the sound signals S1(t) of a sound source 1 closer to one microphone 111 are signals to be finally obtained as separation signals, and the sound source signals S1(t) and the sound thereof are target sound source signals and target sounds, respectively. And, it is also assumed that sound signals S2(t) of the other sound source 2 and the sounds thereof are called non-target sound source signals and non-target sounds.

In this connection, where SIMO signals composed of four separation signals y11(f), y12(f), y21(f) and y22(f) are made into input signals of a binary masking process of two inputs, six patterns are considered with respect to combinations of input signals to the binary masking process. Among these, three patterns are considered with respect to the combination including the separation signals y11(f) mainly corresponding to the target sound source signals S1(t). However, in compliance with the characteristics of sound source separation process based on the SIMO-ICA method, a combination of y11(f) and y22(f) and a combination of y11(f) and y21(f) qualitatively have features in the same tendency. Therefore, FIG. 9 through FIG. 11 show examples where a binary masking process is carried out for each of the combination of y11(f) and y12(f) and combination of y11(f) and y22(f).

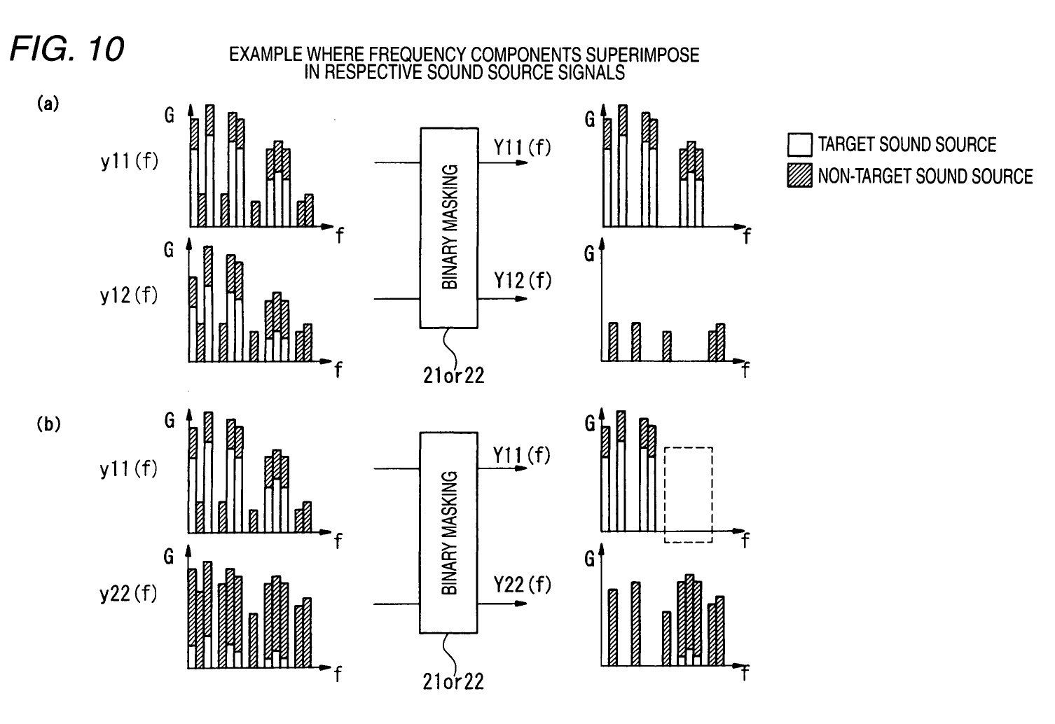

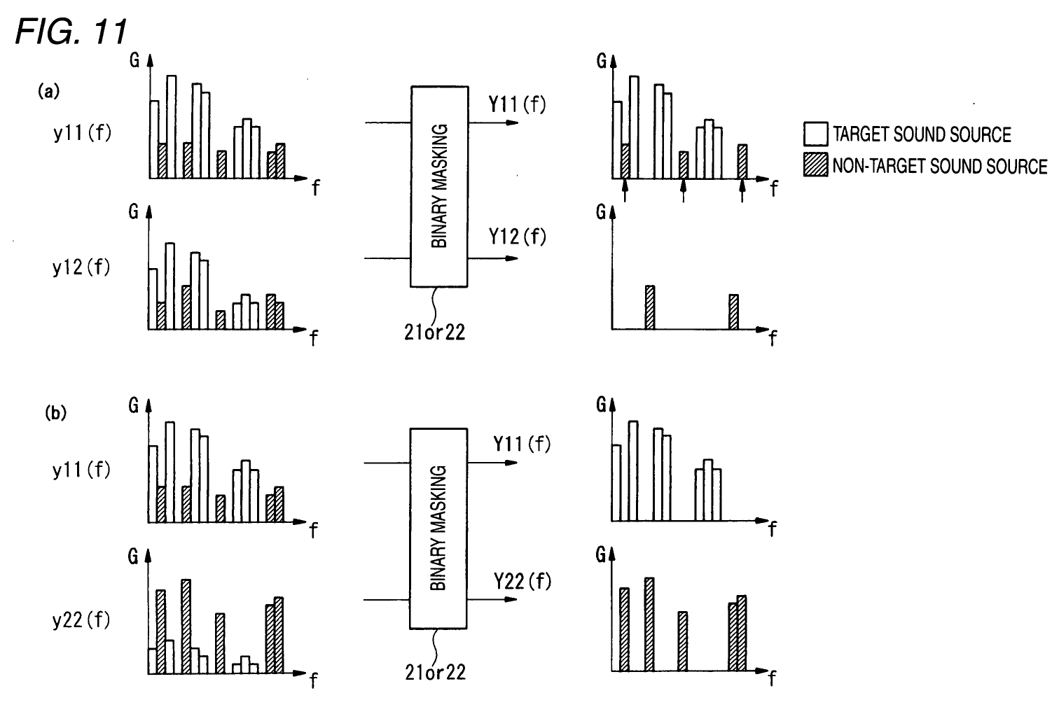

Also, FIG. 9 shows an example where no frequency component superimposes in the respective sound source signals, and FIG. 10 shows an example where the frequency components superimpose therein. On the other hand, FIG. 11 shows an example in which no frequency component superimposes in the respective sound source signals, and the signal level of the target sound source signals S1(t) is comparatively lower than the signal level of the non-target sound source signals S2(t) (that is, the amplitude is small).

Furthermore, FIG. 9(a), FIG. 10(a) and FIG. 11(a) show an example where input signals into the binaural signal processing portion 21 or 22 are made into a combination (SIMO signals) of separation signals y11(f) and y12(f) (hereinafter called pattern a).

On the other hand, FIG. 9(b), FIG. 10(b) and FIG. 11(b) show an example where input signals into the binaural signal processing portion 21 or 22 are made into a combination of separation signals y11(f) and y22(f) (hereinafter called pattern b).

In addition, in FIG. 9 through FIG. 11, bar graphs of the portions corresponding to the frequency components of the target sound source signals S1(t) are expressed with half-tone dot meshing patterns, and bar graphs of the portions corresponding to the frequency components of non-target sound source signals S1(t) are expressed by oblique-lined patterns, respectively.

As shown in FIG. 9 and FIG. 10, the components of sound source signals that are the objects of identification are dominant in the input signals to the binaural signal processing portion 21 or 22. However, components of other sound source signals slightly exist as noise other than the above.

Where a binary masking process is applied to the input signals (separation signals) including such noise, separation signals (Y11(f), Y12(f) and Y11(f) and Y22(f)) in which the first sound source signals and the second sound source signals are satisfactorily separated from each other are obtained regardless of combinations of the input signals where the frequency components of the respective sound source signals do not superimpose each other as shown in the level distribution (the right-side bar graphs) of the output signals in FIG. 9(a) and FIG. 9(b).

Thus, where the frequency components of the respective sound source components do not superimpose each other, the difference in level is made clear, by which in both input signals into the binaural signal processing portion 21 or 22, the signal level in the frequency component of sound source signals that are the object of identification becomes high, and the signal level in the frequency component of the other sound source signals becomes low. Signals can be securely separated by the binary masking process that carries out signal separation in compliance with the signal levels per frequency component. As a result, high separation performance is obtained regardless of the combinations of the input signals.

However, almost all the cases are where the frequency components (frequency bands) superimpose each other between the target sound source signals and the non-target sound source signals generally in an actual acoustic space (acoustic environment). That is, the frequency components more or less superimpose each other between a plurality of sound source signals.

Herein, even in a case where the frequency components of respective sound source signals superimpose each other, as shown in the level distribution (the right-side bar graph) of the output signals Y11(f), Y12(f) in FIG. 10(a), although noise signals (components of the sound source signals other than the object of identification) slightly remain in the frequency components superimposing in the respective sound source signals in the above-described [Pattern a], noise signals can be securely separated in the other frequency components.

In the [Pattern a] shown in FIG. 10(a), both input signals into the binaural signal processing portions 21 and 22 are signals in which the same sound source signals are separated (identified) based on the sound signals recorded by the respective different microphones. The signal levels thereof have differences in level in response to the distance from the sound source of the identification object to the microphone. Therefore, the signals can be easily separated by the differences in level in the binary masking process. This is considered to be a reason why high separation performance can be obtained even where the frequency components in the respective sound source signals superimpose each other.

Furthermore, since, in the [Pattern a] shown in FIG. 10(a), the components of the same sound source signals (target sound source signals S1(t)) are dominant in both input signals (that is, the level of the components of the other mixed sound source signals), the components (noise components) of the sound source signals other than the identification object, the signal level of which is comparatively low, hardly adversely influence signal separation. This is also considered to be one of the reasons why high separation performance is obtained.

On the other hand, where the frequency components of the respective sound source signals superimpose each other, as shown in FIG. 10(b), in the above-described [Pattern b], such a shortcoming occurs, by which the signal components inherently to be output in the output signal (separation signal) Y11(f) (that is, the components of the sound source signals of the identification object) are lost with respect to the frequency components superimposing in the respective sound source signals (the portion enclosed by broken lines in FIG. 10(b)).

Such a loss is a phenomenon that occurs since, with respect to the frequency components, the level of the non-target sound source signals S2(t) of the identification object into the microphone 112 is higher than the input level of the target sound source signals S1(t) into the microphone 112. If such a loss occurs, the sound quality is worsened.

Therefore, generally, if the above-described [Pattern a] is adopted, it can be said that satisfactory separation performance is obtained in many cases.

However, the signal levels of the respective sound source signals change in an actual acoustic environment, and as shown in FIG. 11, there may be cases where the signal level of the target sound source signals S1(t) becomes relatively lower than the signal level of the non-target sound source signals S2(t) according to situations.

In such cases, due to a result that sufficient sound source separation is not carried out by the SIMO-ICA processing portion 10, the components of the non-target sound source signals S2(t) remaining in the separations y11(f) and y12(f) corresponding to the microphone 111 becomes relatively large. For this reason, if the [Pattern a] shown in FIG. 11(a) is adopted, as shown by the arrow in FIG. 11(a), such an inconvenient decrease will occur, in which components of the non-target sound source signals S1(t) remain in the separation signals Y11(f) output as those corresponding to the target sound source signals S1(t). If such a phenomenon occurs, the sound source separation performance is worsened.

On the contrary, if the [Pattern b] shown in FIG. 11(b) is adopted, there is a high probability that the components of the non-target sound source signals S1(t) as shown by the arrow in FIG. 11(a) will be prevented from remaining in the output signals Y11(f).

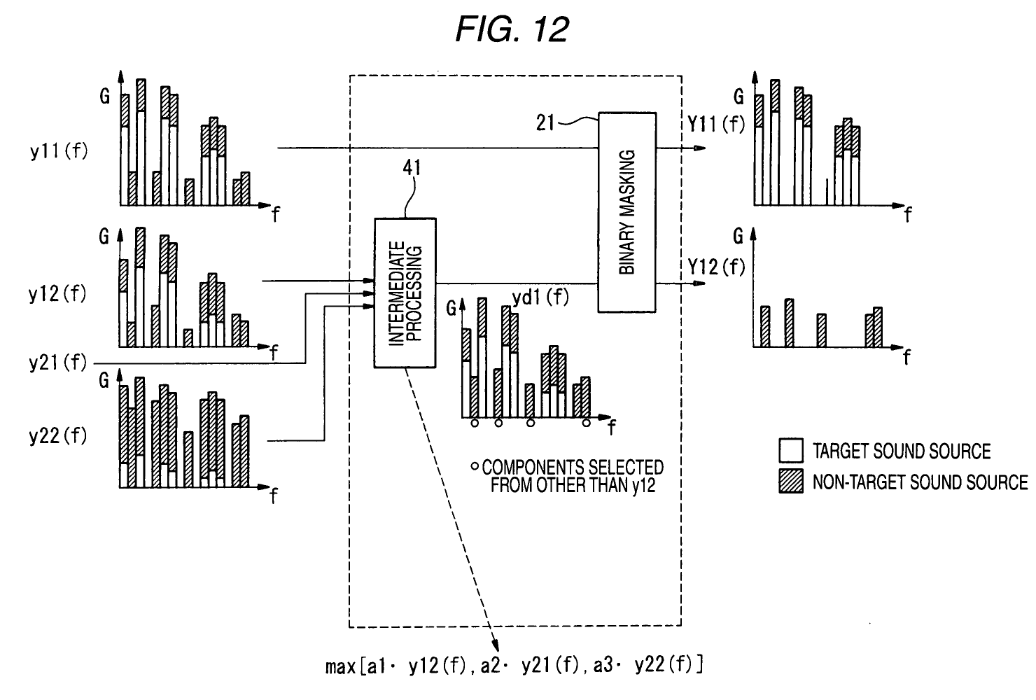

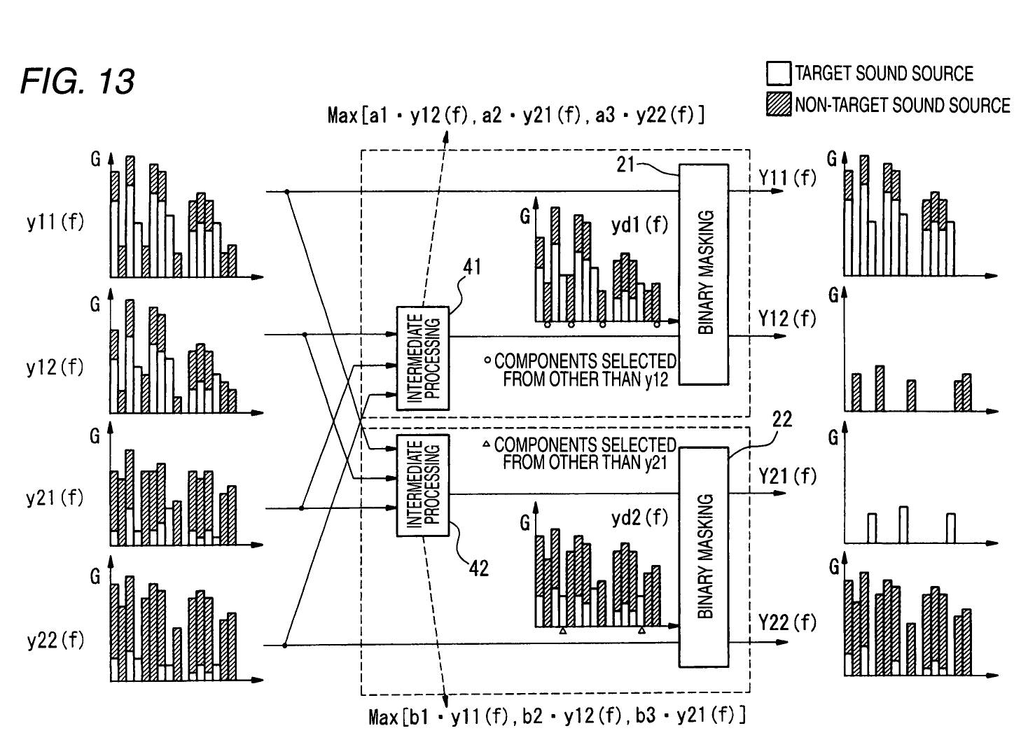

Next, referring to FIG. 12 and FIG. 13, a description is given of effects where a sound source separation process is carried out by the sound source separation apparatus X1.

FIG. 12 is a schematic view showing the description (including the signal level distribution, per frequency component, of the SIMO signals and the signals subjected to a binary masking process) according to Example 1 of a sound source separation process with respect to SIMO signals in the sound source separation apparatus X1. Also, in FIG. 12, only the binaural signal processing portion 21 and the intermediate processing executing portion 41 corresponding thereto are picked up and shown.

In the example shown in FIG. 12, the intermediate processing executing portion 41 first corrects the signal levels (that is, corrects the levels by weighting) of three separation signals y12(f), y21(f) and y22(f) (one example of specified signals) by multiplying the signals of the frequency components by predetermined weighting coefficients a1, a2 and a3 for each of the frequency components equally divided by a predetermined frequency bandwidth, and further carries out an intermediate processing for selecting the signals having the maximum signal level for each of the frequency components from the corrected signals. The intermediate processing may be expressed as Max[a1·y12(f), a2·y21(f), a3·y22(f)].

Furthermore, the intermediate processing executing portion 41 outputs the intermediately processed signals yd1(f) (signals in which signals having the maximum signal level are combined per frequency component) obtained by the intermediate processing to the binaural signal processing portion 21. Herein, a2=0 and 1≧a1>a3. For example, a1=1.0, a3=0.5. Also, since a2=0, marking of the frequency distribution of the separation signals y21(f) is omitted. Furthermore, the SIMO signals shown in FIG. 12 are the same as the SIMO signal shown in FIG. 10.

Thus, of the signals subjected to weighting correction so as to become a1>a3, by making the signals having the maximum signal level, per frequency component into the input signals for a binary masking process, the sound source separation apparatus X1 operates as follows.

That is, with respect to the frequency components in which the separation signals y12(f) are output at the signal level in the range of a1·y12(f)≧a3·y22(f) for the separation signals y22(f), the separation signals y11(f) and separation signals y12(f) are input in the binaural signal processing portion 21, wherein it is considered that satisfactory signal separation situations as shown in FIG. 9(a) and FIG. 10(a) can be obtained.

On the other hand, with respect to the frequency components in which the separation signals y12(f) are lowered to the signal level in the range of a1·y12(f)<a3·y22(f) for the separation signal y22(f), the separation signals y11(f) and signals in which the separation signals y22(f) are reduced and corrected to (a3) times are input in the binaural signal processing portion 21, where it is considered that satisfactory signal separation situations as shown in FIG. 9(a) and FIG. 11(b) are obtained.

FIG. 13 is a schematic view showing the description (including SIMO signals and the signal level distribution, per frequency component, of the signals subjected to a binary masking process) of Example 2 of a sound source separation process for the SIMO signals in the sound source separation apparatus X1.

Also, in the example shown in FIG. 13, as in the example shown in FIG. 12, the intermediate processing executing portion 41 first corrects the signal levels (that is, corrects the levels by weighting) of three separation signals y12(f), y21(f) and y22(f) (one example of specified signals) by multiplying the signals of the frequency components by predetermined weighting coefficients a1, a2 and a3 for each of the frequency components equally divided by a predetermined frequency bandwidth, and further carries out an intermediate processing (in the drawing, this is expressed as Max[a1·y12(f), a2·y21(f), a3·y22(f)]) for selecting the signals having the maximum signal level for each of the frequency components from the corrected signals. Furthermore, the intermediate processing executing portion 41 outputs the intermediately processed signals yd1(f) (signals in which signals having the maximum signal level are combined per frequency component) obtained by the intermediate processing to the binaural signal processing portion 21. For example, 1≧a1>a2>a3≧0.

Similarly, the intermediate processing executing portion 42 first corrects the signal levels of three separation signals y11(f), y12(f) and y21(f) (one example of specified signals) by multiplying the signals of the frequency components by predetermined weighting coefficients b1, b2 and b3 for each of the frequency components equally divided by a predetermined frequency bandwidth, and further carries out an intermediate processing (in the drawing, this is expressed as Max[b1·y11(f), b2·y12(f), b3·y21(f)]) for selecting the signals having the maximum signal level for each of the frequency components from the corrected signals. Furthermore, the intermediate processing executing portion 42 outputs the intermediately processed signals yd2(f) (signals in which signals having the maximum signal level are combined per frequency component) obtained by the intermediate processing to the binaural signal processing portion 22. For example, 1≧b1>b2>b3≧0. Also, the SIMO signals shown in FIG. 13 are the same as the SIMO signals shown in FIG. 10.

In such Example 2, actions and effects similar to those described in Example 1 described above (Refer to FIG. 12) can be brought about.

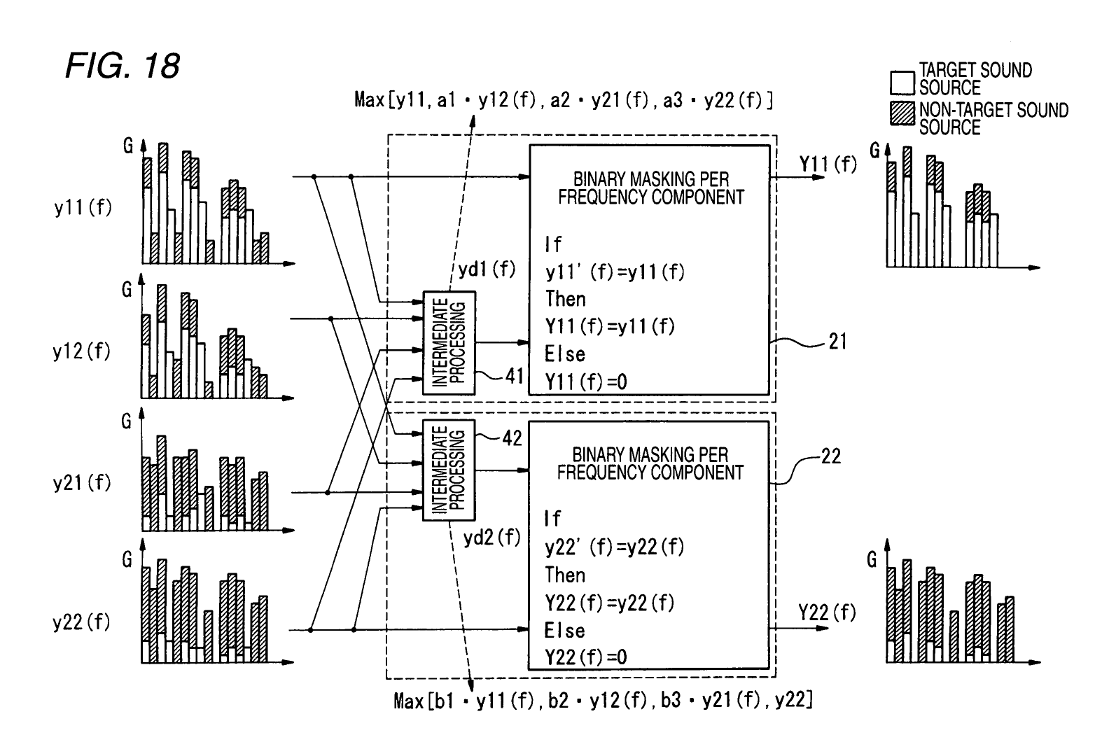

FIG. 18 is a schematic view showing the description (including SIMO signals and signal level distribution, per frequency component, of the signals subjected to a binary masking process) of Example 3 of a sound source separation process with respect to the SIMO signal in the sound source separation apparatus X1.

Example 3 shown in FIG. 18 is the sound source separation apparatus X1 that executes substantially the same process as that of Example 2 described above (Refer to FIG. 13) as the entirety, excepting that there are slight differences in the process executed by the intermediate processing executing portion 41 and the processes executed by the binaural signal processing portions 21,22 from Example 2 shown in FIG. 13.

That is, in Example 3 shown in FIG. 18, the intermediate processing executing portion 41 first corrects (that is, corrects by weighting) the signal levels by multiplying the signals of the frequency components by predetermined weighting coefficients (1, a1, a2, a3) per frequency component equally divided by a predetermined frequency width with respect to four separation signals y11(f), y12(f), y21(f), and y22(f) (one example of specified signals), and carries out an intermediate processing (in the drawing, expressed as Max[y11, a1·y12(f), a2·y21(f), a3·y22(f)] for selecting the signals having the maximum signal level, per frequency component described above, from the corrected signals. In addition, the intermediate processing executing portion 41 outputs the intermediately processed signals yd1(f) (the signals in which signals having the maximum signal level per frequency component are combined) that are obtained from the intermediate processing to the binaural signal processing portion 21. For example, 1≧a1>a2>a3≧0.

Similarly, the intermediate processing executing portion 42 first corrects the signal levels by multiplying the signals of the frequency components by predetermined weighting coefficients (b1, b2, b3, 1) per frequency component equally divided by a predetermined frequency width with respect to four separation signals y11(f), y12(f), y21(f), and y22(f) (one example of specified signals), and carries out an intermediate processing (in the drawing, expressed as Max [b1·y11, b2·y12(f), b3·y21(f), y22(f)] for selecting the signals having the maximum signal level, per frequency component described above, from the corrected signals. In addition, the intermediate processing executing portion 42 outputs the intermediately processed signals yd2(f) (the signals in which signals having the maximum signal level per frequency component are combined) that are obtained from the intermediate processing to the binaural signal processing portion 22. For example, 1≧b1>b2>b3≧0. Also, the SIMO signals shown in FIG. 18 are the same as the SIMO signals shown in FIG. 10.

Here, the binaural signal processing portion 21 according to Example 3 executes the following processes per frequency component with respect to the signals (the separation signals y11(f) and the intermediately processed signals yd1(f)) input therein.

That is, the binaural signal processing portion 21 adopts the components of the intermediately processed signals yd1(f) or the separation signals y11(f) as signal components of the output signals Y11(f) for each of the frequency components where the signal level of the intermediately processed signals yd1(f) is equal to the signal level of the separation signals y11(f), and if not, adopts a constant value (herein, 0 value), which is defined in advance, as the signal component of the output signal Y11(f).

Similarly, where the signal level of the separation signals y22(f) is equal to the signal level of the intermediately processed signal yd2(f) (that is, the same signals), the binaural signal processing portion 22 according to Example 3 adopts the components of the separation signals yd2(f) or the intermediately processed signals yd2(f) as the signal components of the output signals Y22(f) with respect to the signals (the separation signals y22(f) and the intermediately processed signals yd2(f)) per frequency component, and if not, adopts a constant value (herein, 0 value), which is defined in advance, as the signal component of the output signals Y22(f).

Here, where a general binary masking process is executed, the binaural signal processing portion 21 adopts the component of the separation signal y11(f) as the signal component of the output signal Y11(f) per frequency component if the signal level of the separation signal y11(f) is higher than the signal level of the intermediately processed signals yd1(f) (y11(f)≧yd1(f)), and if not, adopts a constant value (herein, 0 value), which is defined in advance, as the signal component of the output signal Y11(f).

However, in the intermediate processing executing portion 41, the signals in which signals having the maximum signal level are selected per frequency component are made into the intermediately processed signals yd1(f) with respect to the separation signals y11(f) that becomes the object of a binary masking process (that are multiplied by a weighting coefficient [1]) and the other separation signals y12(f), y21(f) and y22(f) multiplied by weighting coefficients a1 through a3. Therefore, as described above, even if the binaural signal processing portion 21 adopts the components of the separation signal y11(f) or the intermediately processed signal yd1(f) as the signal components of the output signal Y11(f) where [y11(f)=yd1(f)], the binaural signal processing portion 21 is substantially the same as (that is, equivalent to) a portion for executing a general binary masking process. This is the same for the binaural signal processing portion 22.

Here, the general binary masking process is a process to change over whether, as the signal components of the output signal y11(f), the components of the separation signal y11(f) or the intermediately processed signals yd1(f) are adopted or the constant value (0 value) is adopted, based on whether or not [y11(f)≧yd1(f)].

In Example 3 described above, actions and effects similar to those described in Example 1 (refer to FIG. 12) are brought about.

Next, a description is given of experimental results of sound source separation performance evaluation using the sound source separation apparatus X1.

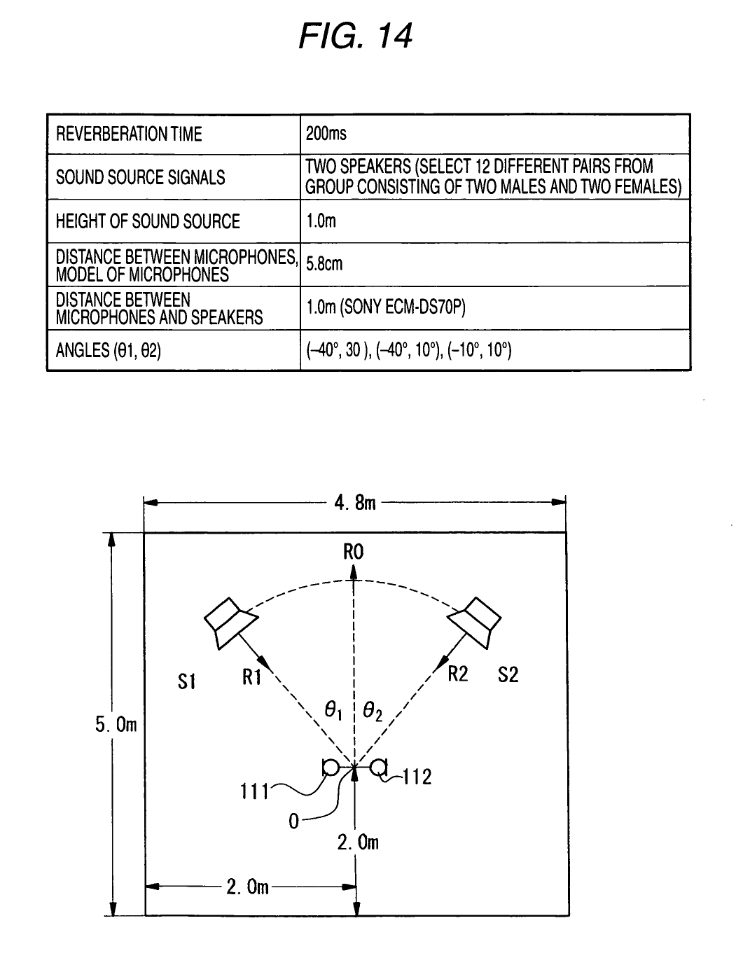

FIG. 14 is a view describing experimental conditions of the sound source separation performance evaluation using the sound source separation apparatus X1.

As shown in FIG. 14, the experiment for evaluation of sound source separation performance is based on experimental conditions where two speakers existing at two different predetermined places in a room whose area is 4.8 m wide and 5.0 m long are used as sound sources, sound signals (speakers' voices) from the respective sound sources (speakers) are input by means of two microphones 111,112 the directions of which are opposed to each other, and performance of separating sound signals (sound source signals) of the respective speakers is evaluated. Here, the experiments were carried out under the condition that the speakers who become sound sources are prepared by twelve pairs each consisting of two speakers selected from two males and two females (four in total) (even where the same two speakers are made into sound sources, different conditions are brought about if the arrangement of the two persons is replaced), and the evaluation of the sound source separation performance is based on the average values of the evaluation values under the respective combinations thereof.

Also, under any one of the experimental conditions, the reverberation time was set to 200 milliseconds, the distance from each speaker (sound source) to the nearest microphone is 1.0 meter, and two microphones 111 and 112 were placed with spacing of 5.8 centimeters. Also, the model of the microphones was ECMDS70P (SONY Corporation).

Here, where it is assumed that, when being observed from the upside, where the direction orthogonal to the orientation of both microphones 111 and 112 opposed to each other is made into the reference direction R0, the angle formed by the reference direction R0 and the direction R1 from one sound source S1 (speaker) to the interim point O between both the microphones 111 and 112 is θ1, and the angle formed by the reference direction R0 and the direction R2 from the other sound source S2 (speaker) to the interim point O described above is θ2. At this time, related devices are arranged so that combinations of θ1 and θ2 are set to three pattern conditions (θ1,θ2)=(−40°, 30°), (−40°, 10°), and (−10°, 10°), and experiments were carried out under the respective conditions.

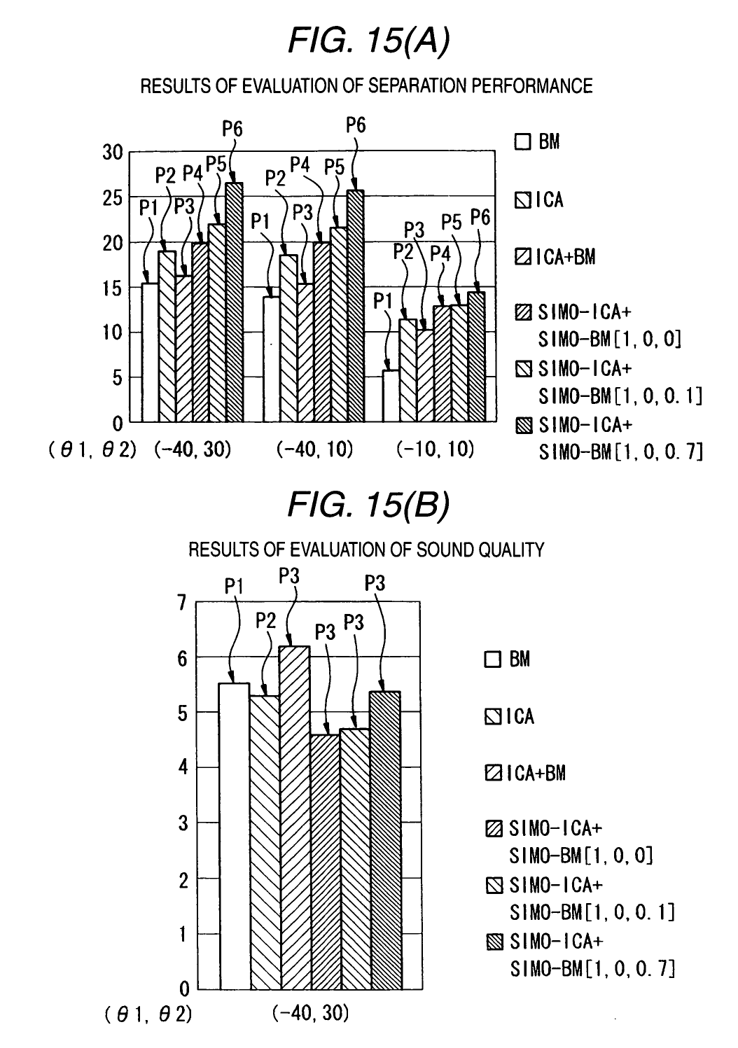

FIGS. 15(a) and (b) are graphs showing the results of evaluation regarding the sound source separation performance and the sound quality of sounds after being separated when sound sources are separated under the above-described experimental conditions by a related sound source separation apparatus and the sound source separation apparatus according to the present invention.

Herein, the NRR (Noise Reduction Ratio) was used as the evaluation value (the vertical axis of the graph) of the sound source separation performance shown in FIG. 15(a). The NRR is an index showing the degree of noise elimination, the unit of which is (dB). It can be said that the larger the NRR is, the higher the sound source separation performance is.

In addition, the CD (Cepstral Distortion) was used as the evaluation value (the vertical axis of the graph) of sound quality shown in FIG. 15(b), and the CD is an index showing the degree of sound quality, the unit of which is (dB). The CD expresses a spectral distortion of sound signals, which expresses the distance of spectral envelope between original sound source signals that becomes an object of separation, and the separation signals obtained by separating the sound source signals from mixed sound signals. It can be said that the smaller the CD value is, the better the sound quality is. Furthermore, the results of sound quality shown in FIG. 15(b) are only in the case where ((θ1,θ2)=(−40°, 30°).

Markings P1 through P6 in the drawing corresponding to the respective bar graphs express the processing results in the following cases.

Marking P1(BM) expresses the results where a binary masking process was carried out.

Marking P2(ICA) expresses the results where a sound source separation process was carried out based on the FD-SIMO-ICA method shown in FIG. 6.

Marking P3(ICA+BM) expresses the results where a binary masking process was applied to the SIMO signals obtained by a sound source separation process (sound source separation apparatus Z4) based on the FD-SIMO-ICA method shown in FIG. 6. That is, the results correspond to those where a sound source separation process was carried out by the configuration shown in FIG. 9 through FIG. 11.

Markings P4-P6 (SIMO-ICA+SIMO-BM) express the results where a sound source separation process was carried out by the sound source separation apparatus X1 shown in FIG. 2. Herein, P4 shows a case where the correction coefficient [a1,a2,a3]=[1.0,0,0], P5 shows a case where the correction coefficient [a1,a2,a3]=[1.0,0,1], P6 shows a case where the correction coefficient [a1,a2,a3]=[1.0,0,0.7]. Hereinafter, the conditions of the respective correction coefficients of P4, P5, and P6 are called Correction Pattern P4, Correction Pattern P5, and Correction Pattern P6, respectively.

Based on the graphs shown in FIG. 15, it is understood that the sound source separation processes (P4 through P6) according to the present invention, which carries out a sound source separation process by carrying out an intermediate processing based on the SIMO signals obtained by a sound source separation process of the BSS system based on the ICA method and applying a binary masking process using the intermediately processed signals, have a larger NRR value and more excellent sound source separation performance than in cases where a binary masking process or a sound source separation process of the BSS system based on the ICA method is independently carried out (P1, P2), and where a binary masking process is applied to the SIMO signals thereby obtained (P3).

Similarly, it is understood that the sound source separation processes (P4 through P6) according to the present invention have a smaller CD value and a higher sound quality in the sound signals after being separated, than in the sound source separation processes of P1 through P3.

Also, in the sound source separation processes (P4 through P6) according to the present invention, improvement in the sound source separation performance and improvement in the sound quality performance are well balanced where the correction pattern is set to P4 and P5. It is considered that this is because the sound source separation performance and the sound quality performance are increased since such an inconvenient phenomenon described using FIG. 10 and FIG. 11 hardly occurs.

On the other hand, although with the correction pattern P6, further higher sound source separation performance (a higher NRR value) can be obtained than the correction patterns P4 and P5, the sound quality performance is slightly sacrificed (that is, the CD value is slightly higher). It is considered that this is because the frequency of occurrence of such an inconvenient phenomenon as described using FIG. 10 is slightly increased while the frequency of occurrence of such an inconvenient phenomenon described using FIG. 11 is further reduced, and the sound source separation performance is further improved, and resultantly the sound quality performance is slightly sacrificed.

As described above, with the sound source separation apparatus X1, a sound source separation process responsive to an emphasized target (sound source separation performance or sound quality performance) is enabled only by adjusting parameters (weighting coefficients a1 through a3 and b1 through b3) used for the intermediate processing in the intermediate processing executing portions 41 and 42.

Therefore, if the sound source separation apparatus X1 is provided with an operation input portion such as an adjustment knob, numerical value input operation keys, etc., and further the intermediate processing executing portions 41 and 42 are provided with a function for setting (adjusting) the parameters (herein, weighting coefficients a1 through a3 and b1 through b3) used for the intermediate processing carried out by the intermediate processing executing portions 41, 42 in compliance with information input via the operation input portion, it becomes easy to adjust the apparatus in compliance with an emphasized target.

For example, where the sound source separation apparatus X1 is used for a sound identifying apparatus used for a robot, a car navigation system, etc., the weighting coefficients a1 through a3 and b1 through b3 may be set in the direction along which the NRR value is increased, in order to place priority over noise elimination.

On the other hand, where the sound source separation apparatus X1 is applied to a sound communication apparatus such as a mobile telephone set, a hand-free telephone set, etc., the weighting coefficients a1 through a3 and b1 through b3 may be set in the direction along which the CD value is increased, so that the sound quality is improved.

In further detail, if the weighting coefficients are set so that the ratio of the values of weight coefficients a1 and b1 to the values of weighting coefficients a2,a3,b2 and b3 is further increased, this meets an object of emphasizing the sound source separation performance, and if the weighting coefficients are set so that the ratio is further decreased, this meets an object of emphasizing the sound quality performance.

Also, in the embodiment described above, the examples in which an intermediate processing of Max[a1·y12(f), a2·y21(f), a3·y22(f)] or Max[b1·y11(f), b2·y12(f), b3·y21(f)] was carried out by the intermediate processing executing portion 41 or 42.

However, the above-described intermediate processing is not limited thereto.

The following example is considered as the intermediate processing executed by the intermediate processing executing portion 41 or 42.

That is, first, the intermediate processing executing portion 41 corrects (that is, corrects by weighting) the signal level by multiplying the signal of a frequency component by predetermined weighting coefficients a1, a2, a3 for each of the frequency components equally divided by a predetermined frequency bandwidth with respect to three separation signals y12(f), y21(f) and y22(f) (one example of specified signals). Furthermore, the corrected signals are synthesized (added) per frequency component. That is, the intermediate processing executing portion 41 carries out such an intermediate processing as a1·y12(f)+a2·y21(f)+a3·y22(f).

In addition, the intermediate processing executing portion 41 outputs the intermediately processed signals yd1(f) (those in which signals corrected by weighting per frequency component are synthesized) to the binaural signal processing portion 21.

Even if such an intermediate processing is adopted, actions and effects that are similar to those in the above-described example can be brought about. As a matter of course, the intermediate processing is not limited to these two types of intermediate processing, and it is considered that other intermediate processings can be adopted. Also, such a configuration in which the number of channels is expanded to three or more may be considered.

As described above, the sound source separation process of the BSS system based on the ICA method requires a great deal of computation to improve sound source separation performance, and is not suitable for real-time processing.

On the other hand, although the sound source separation based on binaural signal processing generally does not require much computation and is suitable for real-time processing, the sound source separation performance is inferior to the sound source separation process of the BSS system based on the ICA method.

On the contrary, if the SIMO-ICA processing portion 10 is configured so as to learn the separation matrix W(f) by, for example, the following procedure, a sound source separation apparatus can be achieved, which enables real-time processing while securing separation performance of sound source signals.

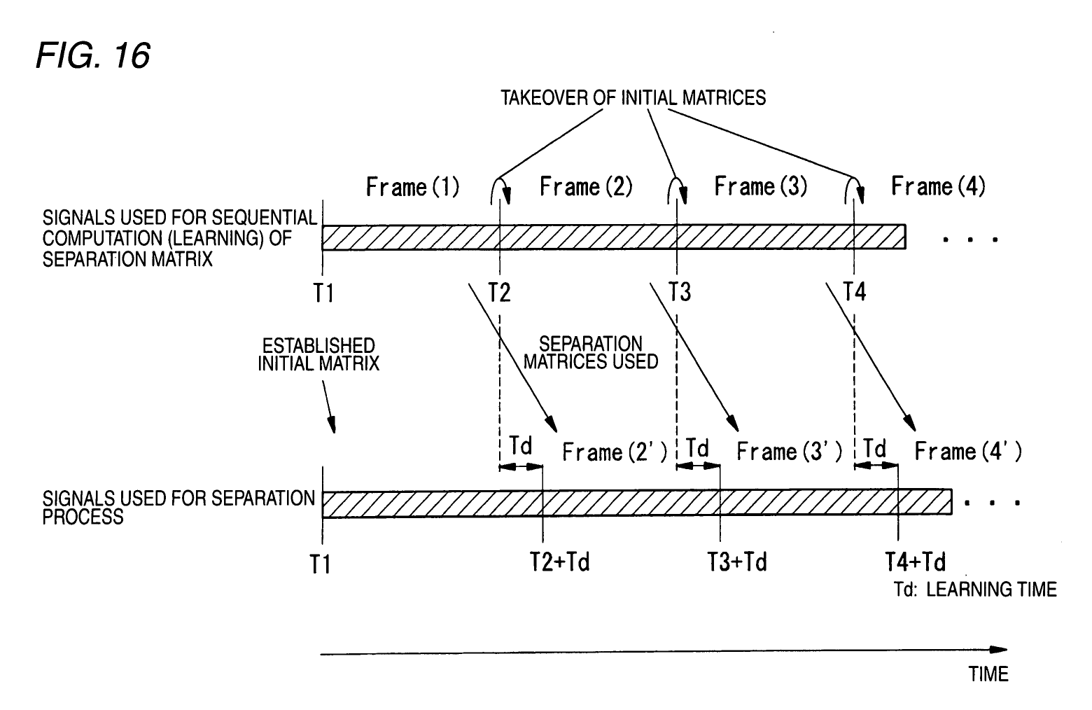

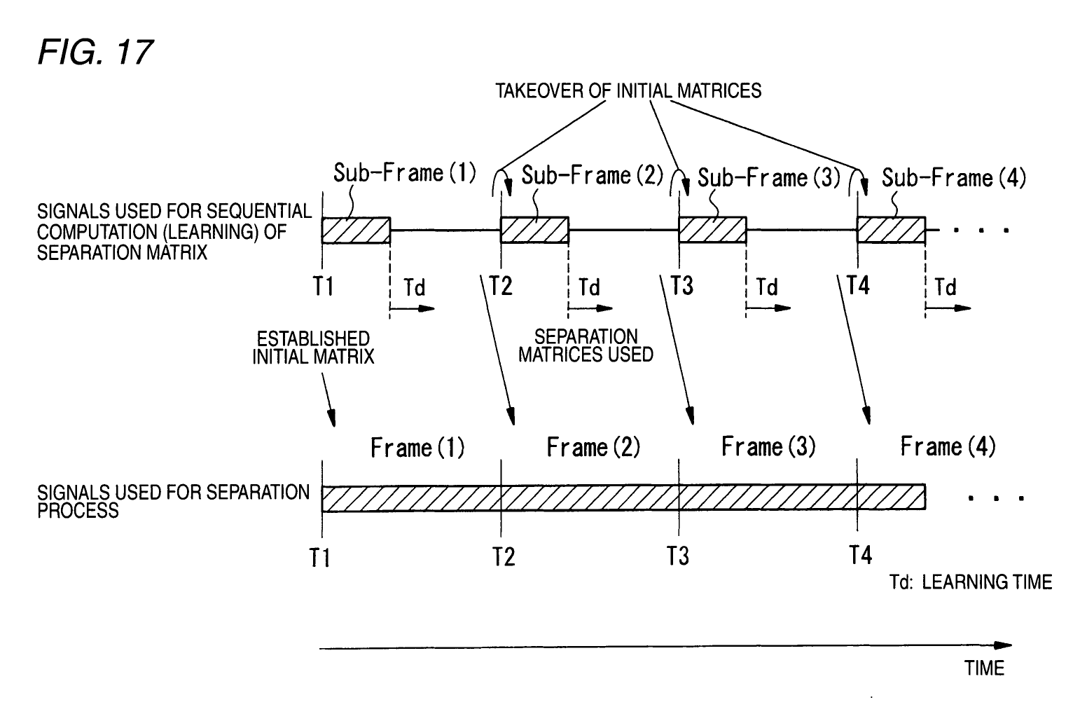

Next, using the timing charts of FIG. 16 and FIG. 17, a description is given of Example 1 (FIG. 16) and Example 2 (FIG. 17) of the relationship between mixed sound signals used for learning the separation matrix W(f) and mixed sound signals to which a sound source separation process is applied by using the separation matrix W(f) obtained by the learning.

Herein, FIG. 16 shows Example 1 of division of mixed sound signals used for computation of the separation matrix W(f) and the sound source separation process, respectively, using a timing chart.

This Example 1 carries out learning computations using all of the sequentially input mixed sound signals for each of the frame signals (hereinafter called a frame), each of which is equivalent to a predetermined time length (for example, 3 seconds), in the sound source separation process of the SIMO-ICA processing portion 10. On the other hand, Example 1 restricts the number of sequential computations of separation matrix in the sound source separation process of the SIMO-ICA processing portion 10. Furthermore, in the example shown in FIG. 1, the SIMO-ICA processing portion 10 executes a learning computation of the separation matrix and a process to generate (identify) separation signals by a filter process (matrix computation) based on the separation matrix, using different frames.

As shown in FIG. 16, the SIMO-ICA processing portion 10 carries out computation (learning) of the separation matrix using frames (i) corresponding to all of the mixed sound signals input in the duration (cycle: Ti+1−Ti) of times Ti through Ti+1, and executes a separation process (filter process) with respect to the frame (i+1)′ corresponding to all the mixed sound signals input in the duration of times (Ti+1+Td) through (Ti+2+Td), using the separation matrix obtained thereby. Herein, Td is time required to learn the separation matrix using a single frame. That is, the SIMO-ICA processing portion 10 carries out a separation process (an identification process) of the mixed sound signals of the next one duration that is shifted only by frame time length+learning time, using the separation matrix computed based on a specified duration of mixed sound signals. At this time, the separation matrix computed (learned) by using the frame (i) of a specified duration is used as a default value (the initial separation matrix) when computing (sequentially computing) a separation matrix by using the frame (i+1)′ of the next duration. Furthermore, the SIMO-ICA processing portion 10 restricts the number of times of repetition of sequential computation (learning computations) of the separation matrices to the number of times executable in the time Td within the range of time length (cycle) equivalent to one frame.

As described above, the SIMO-ICA processing portion 10 that carries out computations of separation matrices in compliance with the timing chart shown in FIG. 16 (Example 1) sequentially executes a separation process based on a predetermined separation matrix for each of the frames (one example of division signal) obtained by dividing the mixed sound signals input in time series by a predetermined cycle and generates the SIMO signal, and carries out sequential computations (learning computation) to obtain the separation matrix, which will be subsequently used, based on the SIMO signals of all the time bands (all the time bands corresponding to the time band of frames (division signals)) generated by the separation process.

Thus, if the learning computation of a separation matrix based on the entirety of one frame is completed within the time length of one frame, the sound source separation process is enabled in real time while reflecting all the mixed sound signals in the learning computations.

However, even where the learning computations are shared by a plurality of processors and are carried out in parallel processing, it can be considered that sufficient learning computations (sequential computation processes) to secure sufficient sound source separation performance are not completed at all times.

Accordingly, the SIMO-ICA processing portion 10 according to Example 1 restricts the number of times of sequential computations of separation matrices to the number of times executable in the time Td accommodated in the range of time (predetermined cycle) of frame (division signals). Thereby, convergence of the learning computation is quickened, and real time processing is enabled.

On the other hand, Example 2 shown in FIG. 17 is an example that carries out learning computations using a part of frame signals at the leading top side for each of the frame signals equivalent to a predetermined time length (for example, 3 seconds) with respect to sequentially input mixed sound signals, that is, an example in which the number of samples of mixed sound signals used in sequential computations of separation matrices is further reduced (thinned) than usual.

Thereby, since the operation amount of learning computations is reduced, learning of separation matrices is enabled in a shorter cycle.

As in FIG. 16, FIG. 17 is a timing chart describing Example 2 of divisions of mixed sound signals used in computation of the separation matrix w(f) and the sound source separation process, respectively.

Also, Example 2 shown in FIG. 17 is an example of executing a learning computation of a separation matrix and a process of generating (identifying) separation signals by a filter process based on the separation matrix, using different frames.

In Example 2, as shown in FIG. 17, computation (learning) of a separation matrix is carried out by using signals (hereinafter called a sub-frame (i)) of a part (for example, signals equivalent to a predetermined time from the leading top) at the leading top side of frames (i) being the mixed sound signals (frames) input in the duration of times (Ti through Ti+1) (Cycle: Ti+1−Ti), and a separation process (filter process) is executed with respect to the frames (i+1) corresponding to all the mixed sound signals input in the time Ti+1 through Ti+2 by using the separation matrix thereby obtained. That is, a separation process (identifying process) of mixed sound signals of the next duration is carried out by using the separation matrix computed based on a part at the leading top side of the mixed sound signals in a specified duration. At this time, the separation matrix computed (learned) by using a part at the leading top side of the frames (i) in a specified duration is used as a default value (initial separation matrix) when computing (sequentially computing) a separation matrix using the frames (i+1) in the next duration. Therefore, it is preferable since the convergence of sequential computation (learning) is quickened.

As described above, the SIMO-ICA processing portion 10 that carries out computations of separation matrices in compliance with the timing chart shown FIG. 17 (Example 2) sequentially executes separation processes based on a predetermined separation matrix for each of the frames (one example of division signals) obtained by dividing the mixed sound signals input in time series by a predetermined cycle, and generates the SIMO signals. Also, it carries out sequential computations (learning computations) of obtaining the separation matrix subsequently used, based on the SIMO signals of all the time bands (all the time bands corresponding to the time bands of frames (division signals)) generated by the separation process.

Furthermore, the SIMO-ICA processing portion 10 corresponding to Example 2 restricts the mixed sound signals used for learning computation to obtain the separation matrix to signals of a time band that is a part of the leading top side for each of the frame signals. Thereby, the learning computation is enabled in a shorter cycle, and resultantly, real-time processing is also enabled.

### INDUSTRIAL APPLICABILITY

The present invention is applicable to a sound source separation system.

1. A sound source separation apparatus, comprising:
a plurality of sound input means into which a plurality of mixed sound signals in which sound source signals from a plurality of sound sources superimpose each other are input;
first sound source separating means for separating and extracting SIMO signals corresponding to at least one sound source signal from the plurality of mixed sound signals by means of a sound source separation process of a blind source separation system based on an independent component analysis method;
intermediate processing executing means for obtaining a plurality of intermediately processed signals by carrying out a predetermined intermediate processing including one of a selection process and a synthesizing process to a plurality of specified signals which is at least a part of the SIMO signals, for each of frequency components divided into a plurality; and
second sound source separating means for obtaining separation signals corresponding to the sound source signals by applying a binary masking process to the plurality of intermediately processed signals or a part of the SIMO signals and the plurality of intermediately processed signals.

2. The sound source separation apparatus according to claim 1, further comprising:
intermediate processing parameter setting means for setting parameters used for the predetermined intermediate processing by predetermined operation inputs.

3. The sound source separation apparatus according to claim 1, wherein
the intermediate processing executing means corrects, by predetermined weighting, signal levels for each of the frequency components with respect to the plurality of specified signals, and carries out one of the selection process and the synthesizing process for each of the frequency components to the plurality of corrected specified signals.

4. The sound source separation apparatus according to claim 3, wherein
the intermediate processing executing means carries out a process of selecting signals having the maximum signal level for each of the frequency components from the plurality of corrected specified signals.

5. The sound source separation apparatus according to claim 1, further comprising:
short-time discrete Fourier transforming means for applying a short-time discrete Fourier transforming process to the plurality of mixed sound signals in a time-domain to transform to a plurality of mixed sound signals in a frequency-domain;
FDICA sound source separating means for generating first separation signals corresponding to the sound source signals for each of the plurality of mixed sound source signals in the frequency-domain by applying a separation process based on a predetermined separation matrix to the plurality of mixed sound signals in the frequency-domain;
subtracting means for generating second separation signals by subtracting the first separation signals from the plurality of mixed sound signals in the frequency-domain; and
separation matrix computing means for computing the predetermined separation matrix in the FDICA sound source separating means by sequential computations based on the first separation signals and the second separation signals,
wherein the first sound source separating means carries out a sound source separation process of a blind source separation system based on a frequency-domain SIMO independent component analysis method.

6. The sound source separation apparatus according to claim 1, wherein
the first sound source separating means carries out a sound source separation process of a blind source separation system based on a combined method in which a frequency-domain independent component analysis method and a projection back method are linked with each other.

7. The sound source separation apparatus according to claim 1, wherein
the first sound source separating means sequentially executes a separation process based on a predetermined separation matrix for division signals for each of the division signals obtained by dividing, by a predetermined cycle, the plurality of mixed sound signals input in time series to generate the SIMO signals, and carries out sequential computations to obtain the predetermined separation matrix subsequently used, based on the SIMO signals corresponding to all time bands of the division signals generated by the separation process, and
the number of times of the sequential computations is limited to the number of times executable in a time of the predetermined cycle.

8. The sound source separation apparatus according to claim 1, wherein
the first sound source separating means sequentially executes a separation process based on a predetermined separation matrix for division signals for each of the division signals obtained by dividing, by a predetermined cycle, the plurality of mixed sound signals input in time series to generate the SIMO signals, and executes, in a time of the corresponding predetermined cycle, sequential computations to obtain the predetermined separation matrix subsequently used, based on the SIMO signals corresponding to a part at a leading top side of time bands of the division signals generated by the separation process.

9. A sound source separating method, comprising:
inputting a plurality of mixed sound signals in which sound source signals from a plurality of sound sources superimpose each other;
separating and extracting SIMO signals corresponding to at least one sound source signal from the plurality of mixed sound source signals by means of a sound source separation process of a blind source separation system based on an independent component analysis method;
obtaining a plurality of intermediately processed signals by carrying out a predetermined intermediate processing including one of a separation process and a synthesizing process to a plurality of specified signals which is at least a part of the SIMO signals, for each of frequency components divided into a plurality; and
obtaining separation signals corresponding to the sound source signals by applying a binary masking process to the plurality of intermediately processed signals or a part of the SIMO signals and the plurality of intermediately processed signals.
